(19) United States
(12) Patent Application Publication
(10) Pub. No.: US 2025/0188108 A1
(43) Pub. Date: Jun. 12, 2025

(54) Metal-Containing Bis(Imino) per-Substituted Aryl Compounds and Methods Thereof

(71) Applicant: ExxonMobil Chemical Patents Inc., Spring, TX (US)

(72) Inventors: Matthew W. HOLTCAMP, Huffman, TX (US); John C. LILLY, Deer Park, TX (US); Ramyaa MATHIALAGAN, Mont Belvieu, TX (US); Kevin A. STEVENS, Houston, TX (US); Irene C. CAI, Webster, TX (US)

(21) Appl. No.: 18/846,181

(22) PCT Filed: Feb. 20, 2023
(86) PCT No.: PCT/US2023/062899

§ 371 Date: Sep. 11, 2024

Related U.S. Application Data
(60) Provisional application No. 63/319,663, filed on Mar. 14, 2022.

(51) Int. Cl. C07F 15/02; C08F 10/04; C08F 10/14

(52) U.S. Cl. CPC C07F 15/025; C08F 10/04; C08F 10/14

(57) ABSTRACT

The present disclosure related to metal-containing compounds that, in some embodiments, are compounds represented by Formula (I). M is Fe or Co. Each of R⁸, R⁹, R¹⁰, R¹³, R¹⁴, and R¹⁵ is independently C₁-C₄₀ hydrocarbyl, —OR¹⁶, —NR¹⁷2, halogen, or five-, six-, or seven-membered heterocyclic ring comprising at least one atom selected from the group consisting of N, P, O and S. Each of R⁶, R⁷, R¹¹, and R¹² is independently C₁-C₄₀ hydrocarbyl, a heteroatom or a heteroatom-containing group. Each of X¹ and X² is independently an anionic ligand.

### CROSS-REFERENCE TO RELATED APPLICATION

This application claims the benefit of U.S. Provisional Application 63/319,663 filed on Mar. 14, 2022, entitled “Metal-Containing Bis(Imino) per-Substituted Aryl Compounds and Methods Thereof”, the entirety of which is incorporated by reference herein.

### FIELD

The present disclosure relates to 2,6-bis(imino)pyridyl metal compounds, catalyst systems comprising such compounds, and uses thereof.

### BACKGROUND

Olefin polymerization catalysts are of great use in industry and polyolefins are widely used commercially because of their robust physical properties. Hence, there is interest in finding new catalyst systems that increase the marketing value of the catalyst and allow the production of polymers having improved properties.

Useful polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those employing a Ziegler-Natta catalyst, a chromium based catalyst, or a metallocene catalyst. The comonomer content of a polyolefin (e.g., wt % of comonomer incorporated into a polyolefin backbone) influences the properties of the polyolefin (and composition of the copolymers) and is influenced by the polymerization catalyst.

A copolymer composition has a composition distribution, which refers to the distribution of comonomer that forms short chain branches along the copolymer backbone. When the amount of short chain branches varies among the copolymer molecules, the composition is said to have a “broad” composition distribution. When the amount of comonomer per 1,000 carbons is similar among the copolymer molecules of different chain lengths, the composition distribution is said to be “narrow”.

Like comonomer content, the composition distribution influences the properties of a copolymer composition, for example, stiffness, toughness, environmental stress crack resistance, and heat sealing, among other properties. The composition distribution of a polyolefin composition may be readily measured by, for example, Temperature Rising Elution Fractionation (TREF) or Crystallization Analysis Fractionation (CRYSTAF).

Also, like comonomer content, a composition distribution of a copolymer composition is influenced by the identity of the catalyst used to form the polyolefins of the composition.

Iron-containing catalysts have been shown to be high activity catalysts capable of forming polyethylene. Typical iron-containing catalysts have a nitrogen atom of a heterocyclic moiety (such as pyridine) that chelates the iron atom. More specifically, iron-containing catalysts are typically tridentate in that they have a pyridyl ligand and two imine ligands that each chelate the iron atom. Chelation of a nitrogen atom of the pyridyl and imine ligands to the iron atom occurs via the lone pair of π-electrons on each of the nitrogen atoms. Such iron-containing catalysts, for example 2,6-bis(imino)pyridyl iron(II) dihalide, typically provide low molecular weight polymers. (W. Zhang, et al., Dalton Trans., 2013, 42, pp. 8988-8997; B. L. Small, Acc. Chem. Res., 2015, 48, pp. 2599-2611). Other iron-containing catalysts include 2-[1-(2,6-dibenzhydryl-4-methylphenylimino)ethyl]-6-[1-(aryl-imino)-ethyl]pyridyl iron catalysts.

It is typically difficult for such catalysts to provide a combination of desirable density, molecular weight, molecular weight distribution, melt index, and melt index ratio at desirable catalyst activities. In addition, iron catalysts having silyl neopentyl ligands bonded to the iron atom have shown improved molecular weight and catalyst activity as compared to their unsubstituted counterparts. However, further improvements in molecular weight and catalyst activity are needed.

There is a need for catalysts capable of forming polyolefins. In particular, there is a need to develop new and improved metal-containing catalysts capable of forming polymers at high catalyst activities and the polymers having a high molecular weight, high density in the presence of alpha-olefins, and fractional melt index.

References for citing in an Information Disclosure Statement (37 CFR 1.97(h)): US 2021/0179650; WO2020/096735; Cámpora, J., Naz, A. M., Palma, P., Álvarez, E. Organometallics, 2005, 24, 4878-4881; EP 2 003 166 A1; WO 2007/080081 A2; U.S. Ser. No. 10/927,204.

### SUMMARY

The present disclosure relates to catalyst compounds represented by Formula (I):

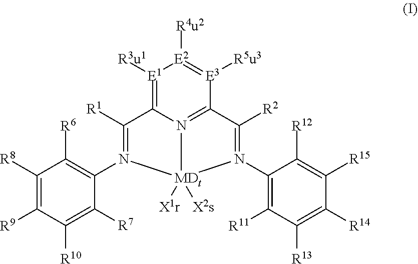

wherein:
M is Fe or Co;
each of R¹ and R² is independently hydrogen, C₁-C₄₀ hydrocarbyl, or five-, or six-, or seven-membered heterocyclic ring comprising at least one atom selected from the group consisting of N, P, O and S; wherein each of R¹ and R² is optionally substituted with halogen, —OR¹⁶, or —NR⁷₂;
each of R³, R⁴, and R⁵ is independently hydrogen, C₁-C₄₀ hydrocarbyl, —OR¹⁶, —NR¹⁷₂ halogen, or five-, six-, or seven-membered heterocyclic ring comprising at least one atom selected from the group consisting of N, P, O and S; wherein each of R³, R⁴, and R⁵ is optionally substituted with halogen, —OR¹⁶, or —NR¹⁷₂;
each of R⁸, R⁹, R¹⁰, R¹³, R¹⁴, and R¹⁵ is independently C₁-C₄₀ hydrocarbyl, —OR¹⁶, —NR¹⁷₂, halogen, or five-, six-, or seven-membered heterocyclic ring comprising at least one atom selected from the group consisting of N, P, O and S; wherein each of R³, R⁴, R⁵, R⁸, R⁹, R¹⁰, R¹³, R¹⁴, and R¹⁵ is optionally substituted with halogen, —OR¹⁶, or —NR¹⁷₂;
each of R⁶, R⁷, R¹¹, and R¹² is independently C₁-C₄₀ hydrocarbyl, a heteroatom or a heteroatom-containing group; wherein each of R⁶, R⁷, R¹¹, and R¹² is optionally substituted with halogen, —OR¹⁶, or —NR¹⁷₂
wherein R¹ optionally is bonded to R³, R² optionally is bonded to R⁵, R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, R¹³ optionally is bonded to R¹¹, R¹⁵ optionally is bonded to R¹², in each case to independently form a five-, six-, or seven-membered carbocyclic or heterocyclic ring, the heterocyclic ring comprising at least one atom from the group consisting of N, P, O and S;
each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
each of E¹, E², and E³ is independently carbon, nitrogen or phosphorus;
u¹ is 0 if E¹ is nitrogen or phosphorus, u² is 0 if E² is nitrogen or phosphorus, u³ is 0 if E³ is nitrogen or phosphorus, u¹ is 1 if E¹ is carbon, u² is 1 if E² is carbon, and u³ is 1 if E³ is carbon;
each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
r is 1 or 2;
s is 1 or 2;
D is a neutral donor;
t is 0 to 2; and
the sum of r, s, and t is 3 or less.

In yet another embodiment, the present disclosure provides a catalyst system including an activator and a catalyst compound of the present disclosure.

In still another embodiment, the present disclosure provides a polymerization process including contacting one or more olefin monomers with a catalyst system including an activator and a catalyst of the present disclosure.

In still another embodiment, the present disclosure provides a polyolefin formed by a catalyst system and or method of the present disclosure.

### DETAILED DESCRIPTION

Catalyst compounds of the present disclosure are metal-containing compounds including a 2,6-diiminoaryl ligand. In particular, catalyst compounds of the present disclosure have two per-substituted aryl moieties, which has been discovered to provide very high catalyst activities and improved polymer properties. Catalyst compounds of the present disclosure may be capable of forming polymers having low comonomer content. Catalyst compounds of the present disclosure can provide polymers at high catalyst activities. The polymers formed can have a high molecular weight, high density in the presence of alpha-olefins, and fractional melt index.

In another class of embodiments, the present disclosure is directed to polymerization processes to produce polyolefin polymers from catalyst systems including one or more olefin polymerization catalysts, at least one activator, and an optional support.

For example, the present disclosure is directed to a polymerization process to produce a polyethylene polymer, the process including contacting a catalyst system including: (1) one or more metal-containing compounds including a 2,6-diiminoaryl ligand, (2) at least one activator, and (3) optionally at least one support, with ethylene and one or more C₃-C₁₀ alpha-olefin comonomers under polymerization conditions.

For the purposes of the present disclosure, the numbering scheme for the Periodic Table Groups is used as described in Chemical and Engineering News, 63(5), pg. 27 (1985).

The following abbreviations may be used herein: Me is methyl, Et is ethyl, Ph is phenyl, tBu is tertiary butyl, PDI is polydispersity index, MAO is methylalumoxane, SMAO is supported methylalumoxane, NMR is nuclear magnetic resonance, ppm is part per million, THE is tetrahydrofuran, RPM is revolutions per minute.

As used herein, “olefin polymerization catalyst(s)” refers to any catalyst, such as an organometallic complex or compound that is capable of coordination polymerization addition where successive monomers are added in a monomer chain at the organometallic active center.

The terms “substituent,” “radical,” “group,” and “moiety” may be used interchangeably.

An “olefin,” alternatively referred to as “alkene,” is a linear, branched, or cyclic compound of carbon and hydrogen having at least one double bond. For purposes of this specification, when a polymer or copolymer is referred to as including an olefin, the olefin present in such polymer or copolymer is the polymerized form of the olefin. For example, when a copolymer is said to have an “ethylene” content of 35 wt % to 55 wt %, it is understood that the mer unit in the copolymer is derived from ethylene in the polymerization reaction and said derived units are present at 35 wt % to 55 wt %, based upon the weight of the copolymer. A “polymer” has two or more of the same or different mer units. A “homopolymer” is a polymer having mer units that are the same. A “copolymer” is a polymer having two or more mer units that are different from each other. A “terpolymer” is a polymer having three mer units that are different from each other. “Different” is used to refer to mer units indicates that the mer units differ from each other by at least one atom or are different isomerically. Accordingly, the definition of copolymer, as used herein, includes terpolymers. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on. An “ethylene polymer” or “ethylene copolymer” is a polymer or copolymer including at least 50 mol % ethylene derived units, a “propylene polymer” or “propylene copolymer” is a polymer or copolymer including at least 50 mol % propylene derived units, and so on.

The term “alpha-olefin” refers to an olefin having a terminal carbon-to-carbon double bond in the structure thereof ((R^{″}R^{″′})—C═CH₂, where R^{″} and R^{″′} can be independently hydrogen or any hydrocarbyl group; such as R^{″} is hydrogen and R^{″′} is an alkyl group). A “linear alpha-olefin” is an alpha-olefin defined in this paragraph wherein R^{″} is hydrogen, and R^{″} is hydrogen or a linear alkyl group.

For the purposes of the present disclosure, ethylene shall be considered an alpha-olefin.

As used herein, and unless otherwise specified, the term “Cn” means hydrocarbon(s) having n carbon atom(s) per molecule, wherein n is a positive integer. The term “hydrocarbon” means a class of compounds containing hydrogen bound to carbon, and encompasses (i) saturated hydrocarbon compounds, (ii) unsaturated hydrocarbon compounds, and (iii) mixtures of hydrocarbon compounds (saturated and or unsaturated), including mixtures of hydrocarbon compounds having different values of n. Likewise, a “Cₘ-C_{y}” group or compound refers to a group or compound including carbon atoms at a total number thereof from m to y. Thus, a C₁-C₅₀ alkyl group refers to an alkyl group including carbon atoms at a total number thereof of about 1 to about 50.

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

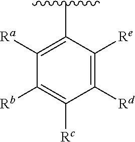

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is hydrocarbyl), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted benzyl” means a benzyl group having 1 or more hydrogen groups replaced by a hydrocarbyl, substituted hydrocarbyl, heteroatom or heteroatom containing group, such as a substituted benzyl group is represented by the formula:

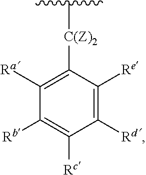

where each of R^{a′}, R^{b′}, R^{c′}, R^{d′}, and R^{e′} and Z is independently selected from hydrogen, C₁-C₄₀ hydrocarbyl or C₁-C₄₀ substituted hydrocarbyl, a heteroatom or a heteroatom-containing group (provided that at least one of R^{a′}, R^{b′}, R^{c′}, R^{d′}, and R^{e′} and Z is not H), or two or more of R^{a′}, R^{b′}, R^{c′}, R^{d′}, R^{e′} and Z are joined together to form a C₄-C₆₂ cyclic or polycyclic ring structure, or a combination thereof.

The terms “hydrocarbyl radical,” “hydrocarbyl group,” or “hydrocarbyl” may be used interchangeably and are defined to mean a group including hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, n-propyl, isopropyl, n-butyl, isobutyl, sec-butyl, tert-butyl, pentyl, iso-amyl, hexyl, octyl cyclopropyl, cyclobutyl, cyclopentyl, cyclohexyl, cyclooctyl, and aryl groups, such as phenyl, benzyl, naphthyl.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl. The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxyl.

The term “alkenyl” means a straight-chain, branched-chain, or cyclic hydrocarbon radical having one or more double bonds. These alkenyl radicals may be optionally substituted. Examples of suitable alkenyl radicals can include ethenyl, propenyl, allyl, 1,4-butadienyl, cyclopropenyl, cyclobutenyl, cyclopentenyl, cyclohexenyl, cycloctenyl, including their substituted analogues.

The terms “alkyl radical,” and “alkyl” are used interchangeably throughout this disclosure. For purposes of this disclosure, “alkyl radical” is defined to be C₁-C₁₀₀ alkyls that may be linear, branched, or cyclic. Examples of such radicals can include methyl, ethyl, n-propyl, isopropyl, n-butyl, isobutyl, sec-butyl, tert-butyl, pentyl, iso-amyl, hexyl, octyl, cyclopropyl, cyclobutyl, cyclopentyl, cyclohexyl, cyclooctyl, including their substituted analogues.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

Unless stated otherwise, description of a moiety (e.g., hydrocarbyl, alkyl, aryl, etc.) embraces unsubstituted and substituted forms of the moiety. Unless otherwise indicated, a “Cₘ-C_{y}” moiety refers to the corresponding unsubstituted moiety including carbon atoms at a total number thereof from m to y, which can be further substituted with one or more heteroatom-containing groups containing additional carbons (such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*3), such that the “Cₘ-C_{y}” moiety, if substituted with one or more heteroatom-containing groups containing additional carbons, possibly includes carbon atoms at a total number exceeding y (for instance, a C₄₀ hydrocarbyl could be substituted at one carbon with —N(CH₃)₂ in place of H on said carbon, such that the total number of carbon atoms in this example moiety would be 42). Thus, more generally, a “C₁-C₄₀ hydrocarbyl”, without further specification, refers to an unsubstituted hydrocarbyl group including carbon atoms at a total number thereof of about 1 to about 40, which optionally can be further substituted with one or more heteroatom-containing groups which also contain additional carbons, such that the base C₁-C₄₀ hydrocarbyl group, if substituted, possibly includes carbon atoms at a total number exceeding 40.

Where isomers of a named alkyl, alkenyl, alkoxide, or aryl group exist (e.g., n-butyl, iso-butyl, sec-butyl, and tert-butyl), reference to an alkyl, alkenyl, alkoxide, or aryl group without specifying a particular isomer (e.g., butyl) expressly discloses all isomers (e.g., n-butyl, iso-butyl, sec-butyl, and tert-butyl).

The term “ring atom” means an atom that is part of a cyclic ring structure. By this definition, a benzyl group has six ring atoms and tetrahydrofuran has five ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

As used herein, Mn is number average molecular weight, Mw is weight average molecular weight, and Mz is z average molecular weight, wt % is weight percent, and mol % is mole percent. Molecular weight distribution (MWD), also referred to as polydispersity (PDI), is defined to be Mw divided by Mn. Unless otherwise noted, all molecular weight units (e.g., Mw, Mn, Mz) are g/mol.

Unless otherwise noted all melting points (Tm) are differential scanning calorimetry (DSC) first melt.

The terms “catalyst compound”, “catalyst complex”, “transition metal complex”, “transition metal compound”, “precatalyst compound”, and “precatalyst complex” are used interchangeably.

A “catalyst system” is a combination of at least one catalyst compound, at least one activator, an optional coactivator, and an optional support material. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The catalyst compound may be neutral as in a precatalyst, or a charged species with a counter ion as in an activated catalyst system. For the purposes of the present disclosure and the claims thereto, when catalyst systems are described as including neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

An “anionic ligand” is a negatively charged ligand which donates one or more pairs of electrons to a metal ion. A “Lewis base” is a neutrally charged ligand which donates one or more pairs of electrons to a metal ion. Examples of Lewis bases include ethylether, trimethylamine, pyridine, tetrahydrofuran, dimethylsulfide, and triphenylphosphine. The term “heterocyclic Lewis base” refers to Lewis bases that are also heterocycles. Examples of heteroyclic Lewis bases include pyridine, imidazole, thiazole, and furan.

A scavenger is a compound that can be added to facilitate polymerization by scavenging impurities. Some scavengers may also act as activators and may be referred to as coactivators. A coactivator, that is not a scavenger, may also be used in conjunction with an activator in order to form an active catalyst. In at least one embodiment, a coactivator can be pre-mixed with the transition metal compound to form an alkylated transition metal compound.

The term “continuous” means a system that operates without interruption or cessation for an extended period of time. For example a continuous process to produce a polymer would be one where the reactants are continually introduced into one or more reactors and polymer product is continually withdrawn.

As used herein, a “composition” includes the components of the composition and/or one or more reaction products of two or more of the components of the composition.

A solution polymerization means a polymerization process in which the polymer is dissolved in a liquid polymerization medium, such as an inert solvent or monomer(s) or their blends. A solution polymerization can be homogeneous. A homogeneous polymerization is one where the polymer product is dissolved in the polymerization medium. Suitable systems may be not turbid as described in J. Vladimir Oliveira, C. Dariva and J. C. Pinto, Ind. Eng. Chem. Res., 2000, Vol. 29, p. 4627.

A bulk polymerization means a polymerization process in which the monomers and or comonomers being polymerized are used as a solvent or diluent using little or no inert solvent as a solvent or diluent. A small fraction of inert solvent might be used as a carrier for catalyst and scavenger. A bulk polymerization system contains less than 25 wt % of inert solvent or diluent, such as less than 10 wt %, such as less than 1 wt %, such as 0 wt %.

### Catalyst Compounds

In at least one embodiment, the present disclosure provides metal-containing compounds having an aryl ligand.

The present disclosure relates to catalyst compounds represented by Formula (I):

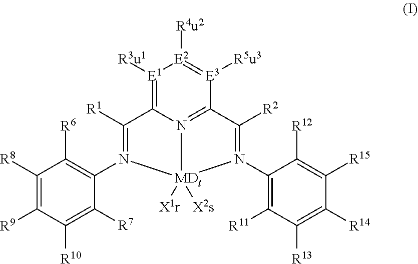

wherein:
M is a Fe or Co;
each of R¹ and R² is independently hydrogen, C₁-C₄₀ hydrocarbyl (such as C₁-C₂₂ alkyl, C₂-C₂₂ alkenyl, C₆-C₂₂ aryl), or five-, or six-, or seven-membered heterocyclic ring comprising at least one atom selected from the group consisting of N, P, O and S; wherein each of R¹ and R² is optionally substituted with halogen, —OR¹⁶, or —NR¹⁷₂; wherein R¹ optionally is bonded to R³, and R² optionally is bonded to R⁵, in each case to independently form a five-, six-, or seven-membered carbocyclic or heterocyclic ring, the heterocyclic ring comprising at least one atom from the group consisting of N, P, O and S;
each of R³, R⁴, and R⁵ is independently hydrogen, C₁-C₄₀ hydrocarbyl (such as C₁-C₂₂ alkyl, C₂-C₂₂ alkenyl, C₆-C₂₂ aryl), —OR¹, —NR¹⁷₂, halogen, or five-, six-, or seven-membered heterocyclic ring comprising at least one atom selected from the group consisting of N, P, O and S;
wherein R³, R⁴, and R⁵ are optionally substituted with halogen, —OR¹⁶, or —NR¹⁷₂; wherein R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, and R¹³ optionally is bonded to R¹¹, in each case to independently form a five-, six-, or seven-membered carbocyclic or heterocyclic ring, the heterocyclic ring comprising at least one atom from the group consisting of N, P, O and S;
each of R⁸, R⁹, R¹⁰, R¹³, R¹⁴, and R¹⁵ is independently C₁-C₄₀ hydrocarbyl (such as C₁-C₂₂ alkyl, C₂-C₂₂ alkenyl, C₆-C₂₂ aryl), —OR¹⁶, —NR¹⁷₂, halogen, or five-, six-, or seven-membered heterocyclic ring comprising at least one atom selected from the group consisting of N, P, O and S; wherein R³, R⁴, R⁵, R⁸, R⁹, R¹⁰, R¹³, R¹⁴, and R¹⁵ are optionally substituted with halogen, —OR¹⁶, or —NR¹⁷₂; wherein R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, and R¹³ optionally is bonded to R¹¹, in each case to independently form a five-, six-, or seven-membered carbocyclic or heterocyclic ring, the heterocyclic ring comprising at least one atom from the group consisting of N, P, O and S;
each of R⁶, R⁷, R¹¹, and R¹² is independently C₁-C₄₀ hydrocarbyl (such as C₁-C₂₂ alkyl, C₂-C₂₂ alkenyl, C₆-C₂₂ aryl), a heteroatom or a heteroatom-containing group (such as —OR¹⁶, —NR⁷₂, halogen, or five-, six-, or seven-membered heterocyclic ring including at least one atom selected from the group consisting of N, P, O and S); wherein R⁶, R⁷, R¹¹, and R¹² are optionally substituted with halogen, —OR¹⁶, or —NR¹⁷₂, wherein R⁶ optionally is bonded to R⁸, R¹¹ optionally is bonded to R¹³, or R¹⁵ optionally is bonded to R¹² in each case to independently form a five-, six-, or seven-membered carbocyclic or heterocyclic ring, the heterocyclic ring comprising at least one atom from the group consisting of N, P, O and S;
each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
each of E¹, E², and E³ is independently carbon, nitrogen or phosphorus;
u¹ is 0 if E¹ is nitrogen or phosphorus, u² is 0 if E² is nitrogen or phosphorus, u³ is 0 if E³ is nitrogen or phosphorus, u¹ is 1 if E¹ is carbon, u² is 1 if E² is carbon, and u³ is 1 if E³ is carbon, each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
r is 1 or 2;
s is 1 or 2;
D is a neutral donor;
t is 0 to 2; and
the sum of r, s, and t is 3 or less.

In some embodiments, M is Fe.

Each of X¹ and X² can be independently selected from hydrocarbyl radicals having from 1 to 20 carbon atoms, halides, hydrides, amides, alkoxides, sulfides, phosphides, dienes, amines, phosphines, ethers, or a combination thereof. In some embodiments, each X is a C₁-C₅ alkyl group, such as each of X¹ and X² is a methyl group. In some embodiments, each of X¹ and X² is independently methyl, ethyl, propyl, butyl, pentyl, hexyl, heptyl, octyl, nonyl, decyl, undecyl, or dodecyl. In some embodiments, each of X¹ and X² is a halide. For example, each of X¹ and X² can be independently chloro or bromo.

In some embodiments, one or more of R¹, R², R³, R⁴, R⁵, R⁶, R⁷, R⁸, R⁹, R¹⁰, R¹¹, R¹², R¹³, R¹⁴, and R¹⁵ is represented by the formula —(R¹⁸)_{q}A(R¹⁹)(R²⁰)(R²¹), wherein: A is Si or Ge; R¹⁸ is C₁-C₁₀ hydrocarbyl; each of R¹⁹, R²⁰, and R²¹ is independently C₁-C₄₀ hydrocarbyl, and q is 0 or 1; wherein R¹⁹ optionally is bonded to R²⁰, R²⁰ optionally is bonded to R²¹, and R¹⁹ optionally is bonded to R²¹, in each case to independently form a five-, six-, or seven-membered carbocyclic or heterocyclic ring, the heterocyclic ring comprising at least one atom from the group consisting of N, P, O and S. Thus, in such embodiments, the referenced R group(s) can be a substituted hydrocarbyl (e.g., where q is 1, such that the R¹⁸ moiety is substituted with the A(R¹⁹)(R²⁰)(R²¹) moiety; and thus in such embodiments at least one of the above-referenced R-groups 1-15 is represented by —(R¹⁸)A(R¹⁹)(R²⁰)(R²¹)).

In various embodiments, A could, for example, be Si. R¹⁸ could preferably be an unsubstituted hydrocarbyl, and for example could be selected from methylene, ethylene, propylene, butylene, pentylene, phenyl, and benzyl (and, in these and other embodiments, q would be 1). Optionally, R¹⁹, R²⁰, and R²¹ together can have at least ten carbon atoms, such as 10 carbon atoms to 50 carbon atoms, such as 10 carbon atoms to 25 carbon atoms, alternatively 15 carbon atoms to 30 carbon atoms. Each of R¹⁹, R²⁰, and R²¹ can be independently C₁-C₄₀ hydrocarbyl, such as C₄-C₄₀ hydrocarbyl, such as C₄-C₄₀ alkyl, such as butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, icosyl, or isomers thereof. Optionally, each of R¹⁹, R²⁰, and R²¹ is independently C₁-C₄₀ unsubstituted hydrocarbyl (i.e. does not contain a heteroatom or hetero-atom containing group). For instance, at least one of R¹⁹, R²⁰, and R²¹ is C₄-C₃₀ alkyl, such as C₈ to C₂₀ alkyl. As another possibility, at least two of R¹⁹, R²⁰, and R²¹ are C₄-C₃₀ alkyl, such as C₆ to C₂₀ alkyl. As another example, two of R¹⁹, R²⁰, and R²¹ are a C₁-C₁₀ alkyl and the remaining one of R¹⁹, R²⁰ and R²¹ is C₅-C₄₀ alkyl, such as C₁₀-C₂₀ alkyl. Or, all of R¹⁹, R²⁰, and R²¹ can be C₄-C₃₀ alkyl, such as C₆ to C₂₀ alkyl.

In some embodiments, —(R¹⁸)_{q}A(R¹⁹)(R²⁰)(R²¹) can be any suitable silane, such as (trialkylsilyl)C₁-C₂₀ alkyl-, such as (trialkylsilyl)C₁-C₁₀ alkyl-, such as (trialkylsilyl)C₁-C₅ alkyl-. In at least one embodiment, —(R¹⁸)_{q}A(R¹⁹)(R²⁰)(R²¹) is independently selected from (tributylsilyl)methyl-, (tripentylsilyl)methyl-, (trilhexylsilyl)methyl-, (triheptylsilyl)methyl-, (trioctylsilyl)methyl-, (trinonylsilyl)methyl-, (decyl)₃(silyl)methyl-, (dimethyl)(n-decyl)silylmethyl-, (diethyl)(n-decyl)silylmethyl-, (dimethyl)(n-undecyl)silylmethyl-, (diethyl)(n-undecyl)silylmethyl-, (dimethyl)(n-dodecyl)silylmethyl-, (diethyl)(n-dodecyl)silylmethyl-, (dimethyl)(n-tridecyl)silylmethyl-, (diethyl)(n-tridecyl)silylmethyl-, (dimethyl)(n-tetradecyl)silylmethyl-, (diethyl)(n-tetradecyl)silylmethyl-, (dimethyl)(n-pentadecyl)silylmethyl-, (diethyl)(n-pentadecyl)silylmethyl-, (dimethyl)(n-hexadecyl)silylmethyl-, (diethyl)(n-hexadecyl)silylmethyl-, (dimethyl)(n-heptadecyl)silylmethyl-, (diethyl)(n-heptadecyl)silylmethyl-, (dimethyl)(n-octadecyl)silylmethyl-, (diethyl)(n-octadecyl)silylmethyl-, (dimethyl)(n-nonadecyl)silylmethyl-, (diethyl)(n-nonadecyl)silylmethyl-, (dimethyl)(icosyl)silylmethyl-, (diethyl)(icosyl)silylmethyl-, or isomers thereof. In some embodiments, —(R¹⁸)_{q}A(R¹⁹)(R²⁰)(R²¹) is (tributylsilyl)methyl or (trihexylsilyl)methyl.

In some embodiments, r is 1. In some embodiments, s is 1. In at least one embodiment, r and s are the same.

In at least one embodiment, each of R¹ and R² is independently C₁-C₂₂ alkyl or C₆-C₂₂ aryl wherein each of R¹ and R² is optionally substituted with halogen. One or more of R¹ and R² may be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl. In at least one embodiment, one or more of R¹ or R² is methyl.

In at least one embodiment, t is 0, in which case D is absent. In an alternate embodiment, D is a neutral donor such as a neutral Lewis base, such as, for example, amines, alcohols, ethers, ketones, aldehydes, esters, sulfides or phosphines, which can be bonded with the metal center or can still be contained in the complex as residual solvent from the preparation of the metal complexes.

In at least one embodiment, at least one of R⁶ or R⁷ is independently halogen, —CF₃, —OR¹⁶, or —NR¹⁷₂. For example, at least one of R⁶ or R⁷ can independently be selected from C₁-C₁₀ alkyl, C₂-C₁₀ alkenyl, C₆-C₁₀ aryl, fluorine, chlorine, bromine, or iodine. R⁸, R⁹, and R¹⁰ can be independently C₁-C₁₀ alkyl, C₂-C₁₀ alkenyl, C₆-C₁₀ aryl, —OR¹⁶, —NR¹⁷₂, halogen, or five-, six-, or seven-membered heterocyclic ring including at least one atom selected from the group consisting of N, P, O and S; where each of R⁸, R⁹, and R¹⁰ is optionally substituted with halogen, —OR¹⁶, or —NR¹⁷₂.

Each of R¹⁶ and R¹⁷ is independently hydrogen, C₁-C₂₂ alkyl, C₂ C₂₂-alkenyl, or C₆-C₂₂ aryl, wherein R¹⁶ and or R¹⁷ is optionally substituted with halogen, or two R¹⁶ and R¹⁷ radicals optionally bond to form a five- or six-membered ring.

In some embodiments, at least one of R⁶, R⁷, R¹¹, and R² is independently a heteroatom or a heteroatom-containing group, or at least one of the R⁶, R⁷, R¹¹, and R¹² is not methyl. In at least one embodiment, at least one of R⁶, R⁷, R¹¹, or R² is independently halogen, —CF₃, —OR¹⁶, or —NR¹⁷₂, such as at least one of the R⁶, R⁷, R¹¹, or R¹² is halogen, or at least one of R⁶, R⁷, R¹¹, or R¹² is methyl, ethyl, propyl, butyl, pentyl, or hexyl. For example, at least one of R⁶, R⁷, R¹¹, or R¹² is independently selected from fluorine, chlorine, bromine, or iodine. In at least one embodiment, R⁶, R⁷, R¹¹, and R¹² are independently selected from methyl, ethyl, tert-butyl, F, Br, Cl, and I.

In at least one embodiment, each of R¹¹, R¹², R¹³, R¹⁴ and R¹⁵ can be independently C₁-C₂₂ alkyl, C₂-C₂₂ alkenyl, C₆-C₂₂ aryl, —OR¹⁶, —NR¹⁷₂, halogen, —NO₂, or five-, six-, or seven-membered heterocyclic ring including at least one atom selected from N, P, O, or S. Each of R¹¹, R¹², R¹³, R¹⁴, or R¹⁵ can be independently substituted with —NO₂, —CF₃, —CF₂CF₃, —CH₂CF₃, halogen, —OR¹⁶, or —NR¹⁷2. Furthermore, each of R¹¹, R¹², R¹³, R¹⁴, and R¹⁵ can be independently C₁-C₂₂ alkyl, C₂-C₂₂ alkenyl, C₆-C₂₂ aryl, where at least one of R¹¹, R¹², R¹³, R¹⁴, and R¹⁵ can be substituted with —NO₂, —CF₃, —CF₂CF₃, —CH₂CF₃, halogen, —OR¹⁶, or —NR¹⁷₂. In at least one embodiment, at least one of R¹¹, R¹², R¹³, R¹⁴, and R¹⁵ is halogen or C₁-C₂₂ alkyl substituted with one or more halogen atoms. In at least one embodiment, each of R¹¹, R¹², R¹³, R¹⁴, and R¹⁵ is independently C₁-C₁₀ alkyl, C₆-C₁₀ aryl, halogen (such as fluorine, chlorine, bromine, or iodine), or trihalomethyl (such as trichloromethyl or trifluoromethyl), where at least one of R¹¹, R¹², R¹³, R¹⁴, or R¹⁵ is halogen or trihalomethyl.

Each of R⁶, R⁷, R⁸, R⁹, R¹⁰, R¹¹, R¹², R¹³, R¹⁴, and R¹⁵ can be independently selected from methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), phenyl, methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl, or isomers thereof.

In at least one embodiment, each of E¹, E², and E³ is independently carbon, nitrogen or phosphorus, such as each of u¹, u², or u³ is independently 0 if E¹, E², or E³ is nitrogen or phosphorus, and each of u¹, u², or u³ is independently 1 if E¹, E², or E³ is carbon. Each of R³, R⁴, and R⁵ can be independently hydrogen or C₁-C₂₂ alkyl. In at least one embodiment, each of E¹, E², and E³ is carbon, and each of R³, R⁴, and R⁵ is hydrogen. In at least one embodiment, each of R³, R⁴, and R⁵ is independently selected from hydrogen, methyl, ethyl, propyl, butyl, pentyl, hexyl, heptyl, octyl, nonyl, decyl, dimethyl-pentyl, tert-butyl, isopropyl, or isomers thereof, such as each of R³, R⁴, and R⁵ is hydrogen.

In at least one embodiment, the catalyst compound represented by Formula (I) is one or more of:

| | |
|---|---|
| 1 | 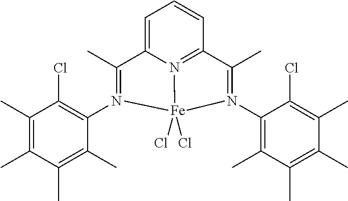 |
| 2 | 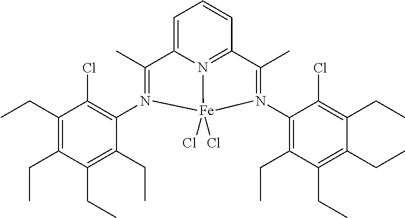 |
| 3 | 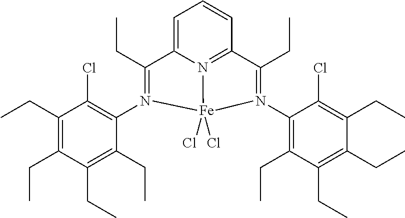 |
| 4 | 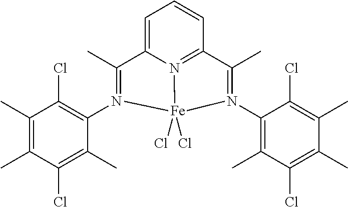 |
| 5 | 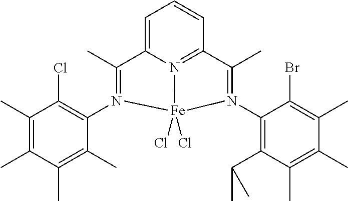 |
| 6 | 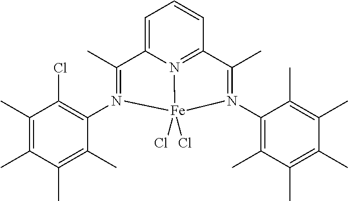 |
| 7 | 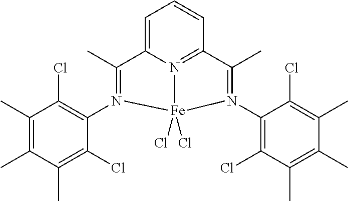 |
| 8 | 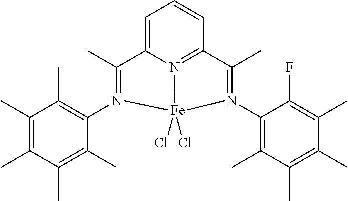 |
| 9 | 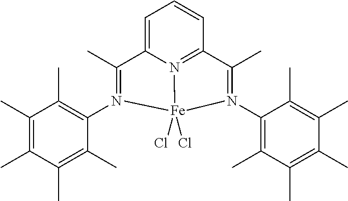 |

In at least one embodiment, two or more different catalyst compounds are present in a catalyst system. In at least one embodiment, two or more different catalyst compounds are present in the reaction zone of a reactor where the polymerization process(es) of the present disclosure occur. When two catalyst compounds are used in one reactor as a mixed catalyst system, the two catalyst compounds can be chosen such that the two are compatible. A simple screening method such as by ¹H or ¹³C NMR, known to those of ordinary skill in the art, can be used to determine which catalyst compounds are compatible. The same activator can be used for both catalyst compounds, however, two different activators, such as a non-coordinating anion activator and an alumoxane, can be used in combination. If one or more catalyst compounds contain an X¹ or X² ligand which is not a hydride, hydrocarbyl, or substituted hydrocarbyl, then the alumoxane may be contacted with the catalyst compound(s) prior to addition of the non-coordinating anion activator.

The two catalyst compounds may be used in any suitable ratio. Molar ratios of (A) transition metal compound to (B) transition metal compound can be (A:B) of 1:1000 to 1000:1, alternatively 1:100 to 500:1, alternatively 1:10 to 200:1, alternatively 1:1 to 100:1, alternatively 1:1 to 75:1, and alternatively 5:1 to 50:1. The suitable ratio chosen will depend on the exact catalyst compounds chosen, the method of activation, and the end product desired. In at least one embodiment, when using the two catalyst compounds, where both are activated with the same activator, mole percentages, based upon the molecular weight of the catalyst compounds, can be from 10% to 99.9% A to 0.1% to 90% B, alternatively 25% to 99% A to 0.5% to 75% B, alternatively 50% to 99% A to 1% to 50% B, and alternatively 75% to 99% A to 1% to 10% B.

### Methods to Prepare the Catalyst Compounds.

The following is a generic description to prepare a catalyst compound of the present disclosure and further exemplified in the examples. All air sensitive syntheses can be carried out in nitrogen purged dry boxes. Solvents can be available from commercial sources. Starting materials (reactants, etc.) may be available from commercial sources.

Bromination of anilines: A substituted aniline can be treated with any suitable brominating agent (e.g., N-bromosuccinimide) at reduced temperature in any suitable solvent (e.g., dichloromethane). After the addition of N-bromosuccinimide, the reaction mixture can be allowed to warm to ambient temperature and stirred for any suitable period of time. The reaction mixture can then be concentrated (e.g., under vacuum) and partitioned between any suitable solvent (such as diethyl ether) and basic aqueous solution (e.g., 1N NaOH). The organic layer can be washed and dried using any suitable drying agent (e.g., MgSO₄), filtered, and dried (e.g., under vacuum). The resulting residue can be purified via filter column of alumina, eluting with any suitable solvent (e.g., hexane) to obtain a substituted bromo-aniline product.

Alkylation of Substituted Bromoaniline: The substituted bromo-aniline product obtained can be treated under any suitable alkylation conditions to substitute bromine with an alkyl group. Alkylation condition can include treating the substituted bromo-aniline product with trialkylboroxine (e.g., trimethylboroxine) and a weak base (e.g., K₂CO₃) using any suitable solvent (e.g., 1,4-dioxane). To this mixture, any suitable palladium catalyst (e.g., Pd(PPh₃)) can be added and the mixture formed can be heated at any suitable temperature (e.g., 115° C.) for any suitable amount of time. The mixture can then be cooled and quenched with water. The pH of the mixture can then be adjusted (e.g., pH=2-3). The mixture can be filtered through Celite. The filtrate can be pH adjusted (e.g., pH=7-8). The filtrate can then be extracted with any suitable solvent (e.g., diethyl ether). The extracted layer can be washed and dried using any suitable drying agent (e.g., MgSO₄), filtered, and concentrated. The concentrated sample can be diluted using any suitable solvent (such as diethyl ether) and flowed through a plug of silica and concentrated again to dryness to obtain the alkylated substituted aniline product.

Chlorination of Alkylated Substituted Aniline: The alkylated substituted aniline product can be treated with any suitable chlorinating agent (e.g., N-Chlorosuccinimide) in any suitable solvent (e.g., CHCl₃, dimethyl sulfoxide) at ambient temperature for any suitable period of time. The reaction mixture may include a base (e.g., N,N-diisopropylethylamine). The reaction mixture can be concentrated and partitioned between an organic solvent (e.g., diethyl ether) and an aqueous solution (e.g., 1N HCl). The organic solvent layer can be dried using any suitable drying agent (e.g., MgSO₄), filtered, and concentrated. The residue can be dissolved in any suitable solvent (e.g., dichloromethane, hexane) and passed through a column/plug of alumina to obtain a chlorinated substituted aniline product.

Formation of Pyridine Diimine Product: The chlorinated substituted aniline product can be treated with a diacetylpyridine compound (e.g., 2,6-diacetylpyridine) and an acid (e.g., formic acid) at ambient temperature for any suitable period of time. The mixture can then be heated to any suitable temperature (e.g., 67° C.) for any suitable period of time. The mixture can then be cooled. Solids formed can be collected via filtration to obtain a pyridine diimine product that includes two moieties of substituted aniline.

Metallation of Pyridine Diimine Product: The pyridine diimine product can be treated with a metal chloride (e.g., iron dichloride) at ambient temperature for any suitable period of time. The reaction mixture can be concentrated to form the metal-containing compound product.

### Activators

The terms “cocatalyst” and “activator” are used herein interchangeably.

The catalyst systems described herein may comprise a catalyst complex as described above and an activator such as alumoxane or a non-coordinating anion and may be formed by combining the catalyst components described herein with activators in any manner known from the literature including combining them with supports, such as silica. The catalyst systems may also be added to or generated in solution polymerization or bulk polymerization (in the monomer). Catalyst systems of the present disclosure may have one or more activators and one, two or more catalyst components. Activators are defined to be any compound which can activate any one of the catalyst compounds described above by converting the neutral metal compound to a catalytically active metal compound cation. Non-limiting activators, for example, may include alumoxanes, aluminum alkyls, ionizing activators, which may be neutral or ionic, and conventional-type cocatalysts. Suitable activators may include alumoxane compounds, modified alumoxane compounds, and ionizing anion precursor compounds that abstract a reactive, σ-bound, metal ligand making the metal compound cationic and providing a charge-balancing non-coordinating or weakly coordinating anion, e.g., a non-coordinating anion.

In at least one embodiment, the catalyst system includes an activator and the catalyst compound of Formula (I).

### Alumoxane Activators

Alumoxane activators are utilized as activators in the catalyst systems described herein. Alumoxanes are generally oligomeric compounds containing —Al(R^{a″′})—O— sub-units, where R^{a″′} is an alkyl group. Examples of alumoxanes include methylalumoxane (MAO), modified methylalumoxane (MMAO), ethylalumoxane and isobutylalumoxane. Alkylalumoxanes and modified alkylalumoxanes are suitable as catalyst activators, such as when the abstractable ligand is an alkyl, halide, alkoxide or amide. Mixtures of different alumoxanes and modified alumoxanes may also be used. It may be suitable to use a visually clear methylalumoxane. A cloudy or gelled alumoxane can be filtered to produce a clear solution or clear alumoxane can be decanted from the cloudy solution. A useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584, which is incorporated by reference herein). Another useful alumoxane is solid polymethylaluminoxane as described in U.S. Pat. Nos. 9,340,630, 8,404,880, and 8,975,209, which are incorporated by reference herein.

When the activator is an alumoxane (modified or unmodified), in at least one embodiment, select the maximum amount of activator at up to a 5,000-fold molar excess Al/M over the catalyst compound (per metal catalytic site). The minimum activator-to-catalyst-compound can be a 1:1 molar ratio. Alternate ranges may include from 1:1 to 500:1, alternately from 1:1 to 200:1, alternately from 1:1 to 100:1, or alternately from 1:1 to 50:1.

In an alternate embodiment, little or no alumoxane is used in the polymerization processes described herein. For example, alumoxane can be present at zero mol %, alternately the alumoxane can be present at a molar ratio of aluminum to catalyst compound transition metal less than 500:1, such as less than 300:1, such as less than 100:1, such as less than 1:1.

### Ionizing/Non-Coordinating Anion Activators

The term “non-coordinating anion” (NCA) means an anion which either does not coordinate to a cation or which is only weakly coordinated to a cation thereby remaining sufficiently labile to be displaced by a Lewis base. “Compatible” non-coordinating anions are those which are not degraded to neutrality when the initially formed complex decomposes. Further, the anion will not transfer an anionic substituent or fragment to the cation so as to cause it to form a neutral transition metal compound and a neutral by-product from the anion. Non-coordinating anions useful in accordance with the present disclosure are those that are compatible, stabilize the transition metal cation in the sense of balancing its ionic charge at +1, and yet retain sufficient lability to permit displacement during polymerization. Suitable ionizing activators may include an NCA, such as a compatible NCA.

It is within the scope of the present disclosure to use an ionizing activator, neutral or ionic. It is also within the scope of the present disclosure to use neutral or ionic activators alone or in combination with alumoxane or modified alumoxane activators.

For descriptions of suitable activators please see U.S. Pat. Nos. 8,658,556 and 6,211,105, incorporated by reference herein.

Additional suitable activators are described in US Patent Publication 2021/0179650, incorporated by reference herein.

In some embodiments, an activator can be one or more of N,N-dimethylanilinium tetrakis(perfluorophenyl)borate, N,N-dimethylanilinium tetrakis(perfluoronaphthyl)borate, dioctadecylmethylammonium tetrakis(perfluorophenyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

In a at least one embodiment, the activator is selected from one or more of a triaryl carbenium (such as triphenylcarbenium tetraphenylborate, triphenylcarbenium tetrakis(pentafluorophenyl)borate, triphenylcarbenium tetrakis-(2,3,4,6-tetrafluorophenyl)borate, triphenylcarbenium tetrakis(perfluoronaphthyl)borate, triphenylcarbenium tetrakis(perfluorobiphenyl)borate, or triphenylcarbenium tetrakis(3,5-bis(trifluoromethyl)phenyl)borate).

Suitable activator-to-catalyst ratio, e.g., all NCA activators-to-catalyst ratio may be about a 1:1 molar ratio. Alternate ranges include from 0.1:1 to 100:1, alternately from 0.5:1 to 200:1, alternately from 1:1 to 500:1, alternately from 1:1 to 1000:1. Suitable ranges can be from 0.5:1 to 10:1, such as 1:1 to 5:1.

It is also within the scope of the present disclosure that the catalyst compounds can be combined with combinations of alumoxanes and NCA's (see for example, U.S. Pat. Nos. 5,153,157; 5,453,410; EP 0 573 120 BI; WO1994/007928; and WO1995/014044 which discuss the use of an alumoxane in combination with an ionizing activator).

Chain transfer agents may be used in polymerization processes of the present disclosure. Useful chain transfer agents can be hydrogen, alkylalumoxanes, a compound represented by the formula A1R₃, ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

Furthermore, a catalyst system of the present disclosure may include a metal hydrocarbenyl chain transfer agent represented by the formula:

Al(R′)₃₋ᵥ(R″)ᵥ

where each R′ can be independently a C₁-C₃₀ hydrocarbyl group, and or each R″, can be independently a C₄-C₂₀ hydrocarbenyl group having an end-vinyl group; and v can be from 0.1 to 3.

### Optional Support Materials

In embodiments herein, the catalyst system may include an inert support material. The supported material can be a porous support material, for example, talc, and inorganic oxides. Other support materials include zeolites, clays, organoclays, or another organic or inorganic support material, or mixtures thereof.

The support material can be an inorganic oxide in a finely divided form. Suitable inorganic oxide materials for use in catalyst systems herein may include groups 2, 4, 13, and 14 metal oxides, such as silica, alumina, and mixtures thereof. Other inorganic oxides that may be employed either alone or in combination with the silica, or alumina can be magnesia, titania, zirconia. Other suitable support materials, however, can be employed, for example, finely divided functionalized polyolefins, such as finely divided polyethylene. Examples of suitable supports may include magnesia, titania, zirconia, montmorillonite, phyllosilicate, zeolites, talc, clays. Also, combinations of these support materials may be used, for example, silica-chromium, silica-alumina, silica-titania. In at least one embodiment, the support material is selected from Al₂O₃, ZrO₂, SiO₂, SiO₂/Al₂O₃, SiO₂/TiO₂, silica clay, silicon oxide/clay, or mixtures thereof.

The support material, such as an inorganic oxide, can have a surface area of about 10 m²/g to about 700 m²/g, pore volume of about 0.1 cm³/g to about 4.0 cm³/g and average particle size of about 5 m to about 500 μm. The surface area of the support material can be of about 50 m²/g to about 500 m²/g, pore volume of about 0.5 cm³/g to about 3.5 cm³/g and average particle size of about 10 m to about 200 m. For example, the surface area of the support material can be about 100 m²/g to about 400 m²/g, pore volume of about 0.8 cm³/g to about 3.0 cm³/g and average particle size can be about 5 m to about 100 m. The average pore size of the support material useful in the present disclosure can be of 10 Å to 1000 Å, such as 50 Å to about 500 Å, and such as 75 Å to about 350 Å. In at least one embodiment, the support material is a high surface area, amorphous silica (surface area=300 m²/gm; pore volume of 1.65 cm³/gm). For example, suitable silicas can be the silicas marketed under the tradenames of DAVISON™ 952 or DAVISON™ 955 by the Davison Chemical Division of W.R. Grace and Company. In other embodiments, DAVISON™ 948 is used. Alternatively, a silica can be ES-70™ silica (PQ Corporation, Malvern, Pennsylvania) that has been calcined, for example (such as at 875° C.).

The support material should be dry, that is, free of absorbed water. Drying of the support material can be effected by heating or calcining at about 100° C. to about 1000° C., such as at least about 600° C. When the support material is silica, it is heated to at least 200° C., such as about 200° C. to about 850° C., and such as at about 600° C.; and for a time of about 1 minute to about 100 hours, about 12 hours to about 72 hours, or about 24 hours to about 60 hours. The calcined support material must have at least some reactive hydroxyl (OH) groups to produce supported catalyst systems of the present disclosure. The calcined support material is then contacted with at least one polymerization catalyst including at least one catalyst compound and an activator.

The support material, having reactive surface groups, such as hydroxyl groups, is slurried in a non-polar solvent and the resulting slurry is contacted with a solution of a catalyst compound and an activator. In at least one embodiment, the slurry of the support material is first contacted with the activator for a period of time of about 0.5 hour to about 24 hours, about 2 hours to about 16 hours, or about 4 hours to about 8 hours. The solution of the catalyst compound is then contacted with the isolated support/activator. In at least one embodiment, the supported catalyst system is generated in situ. In alternate embodiments, the slurry of the support material is first contacted with the catalyst compound for a period of time of about 0.5 hour to about 24 hours, about 2 hours to about 16 hours, or about 4 hours to about 8 hours. The slurry of the supported catalyst compound is then contacted with the activator solution.

The mixture of the catalyst(s), activator(s) and support is heated about 0° C. to about 70° C., such as about 23° C. to about 60° C., such as at room temperature. Contact times can be about 0.5 hours to about 24 hours, such as about 2 hours to about 16 hours, or about 4 hours to about 8 hours.

Suitable non-polar solvents are materials in which all of the reactants used herein, e.g., the activator and the catalyst compound, are at least partially soluble and which are liquid at reaction temperatures. Non-polar solvents can be alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

In at least one embodiment, the support material is a supported methylalumoxane (SMAO), which is an MAO activator treated with silica (e.g., ES-70-875 silica).

### Polymerization Processes

The present disclosure relates to polymerization processes where monomer (e.g., ethylene; propylene), and optionally comonomer, are contacted with a catalyst system including an activator and at least one catalyst compound, as described above. The catalyst compound and activator may be combined in any suitable order. The catalyst compound and activator may be combined prior to contacting with the monomer. Alternatively the catalyst compound and activator may be introduced into the polymerization reactor separately, wherein they subsequently react to form the active catalyst.

Monomers may include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer includes ethylene and an optional comonomer including one or more C₃ to C₄₀ olefins, such as C₄ to C₂₀ olefins, such as C₆ to C₁₂ olefins. The C₃ to C₄₀ olefin monomers may be linear, branched, or cyclic. The C₃ to C₄₀ cyclic olefins may be strained or unstrained, monocyclic or polycyclic, and may optionally include heteroatoms and or one or more functional groups. In another embodiment, the monomer includes propylene and an optional comonomer including one or more ethylene or C₄ to C₄₀ olefins, such as C₄ to C₂₀ olefins, such as C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and or one or more functional groups.

Exemplary C₂ to C₄₀ olefin monomers and optional comonomers may include ethylene, propylene, butene, pentene, hexene, heptene, octene, nonene, decene, undecene, dodecene, norbornene, ethylidenenorbornene, vinylnorbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

Polymerization processes of the present disclosure can be carried out in any suitable manner. Any suitable suspension, homogeneous, bulk, solution, slurry, or gas phase polymerization process can be used. Such processes can be run in a batch, semi-batch, or continuous mode. Homogeneous polymerization processes and slurry processes can be used. A bulk homogeneous process can be used. Alternately, no solvent or diluent is present or added in the reaction medium, (except for the small amounts used as the carrier for the catalyst system or other additives, or amounts found with the monomer; e.g., propane in propylene). In another embodiment, the process is a slurry process. As used herein, the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization may include non-coordinating, inert liquids. Examples of diluents/solvents for polymerization may include straight and branched-chain hydrocarbons, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof, such as can be found commercially (e.g., Isopar™); perhalogenated hydrocarbons, such as perfluorinated C₄ to C₁₀ alkanes, chlorobenzene, and aromatic and alkylsubstituted aromatic compounds, such as benzene, toluene, mesitylene, and xylene. Suitable solvents may also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In at least one embodiment, aliphatic hydrocarbon solvents are used as the solvent, such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof. In another embodiment, the solvent is not aromatic, such as aromatics are present in the solvent at less than 1 wt %, such as less than 0.5 wt %, such as less than 0 wt % based upon the weight of the solvents.

In at least one embodiment, the feed concentration of the monomers and comonomers for the polymerization is 60 vol % solvent or less, such as 40 vol % or less, such as 20 vol % or less, based on the total volume of the feedstream. In at least one embodiment, the polymerization is run in a bulk process.

Polymerizations can be run at any temperature and or pressure suitable to obtain the desired polymers. Suitable temperatures and or pressures include a temperature of about 0° C. to about 300° C., such as about 20° C. to about 200° C., such as about 35° C. to about 160° C., such as about 80° C. to about 160° C., such as about 85° C. to about 140° C. Polymerizations can be run at a pressure of about 0.1 MPa to about 25 MPa, such as about 0.45 MPa to about 6 MPa, or about 0.5 MPa to about 4 MPa.

In a suitable polymerization, the residence time (of catalyst in a reactor) of the reaction can be about 20 minutes to about 8 hours, such as about 20 minutes to about 1 hour.

In at least one embodiment, hydrogen is present in the polymerization reactor at a partial pressure of about 0.001 psig to about 50 psig (0.007 kPa to 345 kPa), such as about 0.01 psig to about 25 psig (0.07 kPa to 172 kPa), such as about 0.1 psig to about 10 psig (0.7 kPa to 70 kPa).

In at least one embodiment, the hydrogen content is about 0.0001 ppm to about 2,000 ppm, such as about 0.0001 ppm to about 1,500 ppm, such as about 0.0001 ppm to about 1,000 ppm, such as about 0.0001 ppm to about 500 ppm. Alternately, hydrogen can be present at zero ppm.

In at least one embodiment, little or no alumoxane is used in the process to produce the polymers. For example, alumoxane can be present at zero mol %, alternately the alumoxane can be present at a molar ratio of aluminum to transition metal less than 500:1, such as less than 300:1, such as less than 100:1, such as less than 1:1.

Unless otherwise indicated, “catalyst productivity” is a measure of how many grams of polymer (P) are produced using a polymerization catalyst comprising W g of catalyst (cat), over a period of time of T hours; and may be expressed by the following formula: P/(T×W) and expressed in units of gPgcat^{-l}hr⁻¹. Unless otherwise indicated, “catalyst activity” is a measure of how active the catalyst is and is reported as the mass of product polymer (P) produced per mole of catalyst (cat) used (kgP/molcat) or as the mass of product polymer (P) produced per mass of catalyst (cat) used (gP/gcat).

In at least one embodiment, according to the present disclosure, a catalyst system has a catalyst activity of greater than 1,000 gP/gCat, such as greater than 15,000 gP/gCat, such as about 2,500 gP/gCat to about 4,500 gP/gCat, such as about 3,000 gP/gCat to about 4,000 gP/gCat, alternatively about 8,000 gP/gCat to about 11,000 gP/gCat.

In at least one embodiment, according to the present disclosure, a catalyst system has a catalyst productivity of greater than 500 gP/gCat/hr, such as greater than 650 gP/gCat/hr, such as about 650 gP/gCat/hr to about 1,000 gP/gCat/hr, such as about 700 gP/gCat/hr to about 850 gP/gCat/hr.

In at least one embodiment, the polymerization: 1) is conducted at temperatures of about 0° C. to about 300° C. (such as about 25° C. to about 250° C., such as about 50° C. to about 160° C., such as about 80° C. to about 140° C.); 2) is conducted at a pressure of atmospheric pressure to about 10 MPa (such as about 0.35 MPa to about 10 MPa, such as about 0.45 MPa to about 6 MPa, such as about 0.5 MPa to about 4 MPa); 3) is conducted in an aliphatic hydrocarbon solvent (such as isobutane, butane, pentane, isopentane, hexanes, isohexane, heptane, octane, dodecane, and mixtures thereof, cyclic and alicyclic hydrocarbons, such as cyclohexane, cycloheptane, methylcyclohexane, methylcycloheptane, and mixtures thereof, such as where aromatics are present in the solvent at less than 1 wt %, such as less than 0.5 wt %, such as at about 0 wt % based upon the weight of the solvents); 4) wherein the catalyst system used in the polymerization comprises less than 0.5 mol %, such as about 0 mol % alumoxane, alternately the alumoxane is present at a molar ratio of aluminum to transition metal less than 500:1, such as less than 300:1, such as less than 100:1, such as less than 1:1; 5) the polymerization occurs in one reaction zone; 6) optionally scavengers (such as trialkyl aluminum compounds) are absent (e.g., present at zero mol %, alternately the scavenger is present at a molar ratio of scavenger metal to transition metal of less than 100:1, such as less than 50:1, such as less than 15:1, such as less than 10:1); and 7) optionally hydrogen is present in the polymerization reactor at a partial pressure of about 0.001 psig to about 50 psig (0.007 kPa to 345 kPa) (such as about 0.01 psig to about 25 psig (0.07 kPa to 172 kPa), such as about 0.1 psig to about 10 psig (0.7 kPa to 70 kPa)). In at least one embodiment, the catalyst system used in the polymerization includes no more than one catalyst compound. A “reaction zone” also referred to as a “polymerization zone” is a vessel where polymerization takes place, for example a stirred-tank reactor or a loop reactor. When multiple reactors are used in a continuous polymerization process, each reactor is considered as a separate polymerization zone. For a multi-stage polymerization in a batch polymerization process, each polymerization stage is considered as a separate polymerization zone. In at least one embodiment, the polymerization occurs in one reaction zone. Room temperature is 23° C. unless otherwise noted.

Other additives may also be used in the polymerization, as desired, such as one or more scavengers, hydrogen, aluminum alkyls, or chain transfer agents such as alkylalumoxanes, a compound represented by the formula A1R₃ or ZnR₂ (where each R is, independently, a C₁-C₈ aliphatic radical, such as methyl, ethyl, propyl, butyl, pentyl, hexyl octyl or an isomer thereof) or a combination thereof, such as diethyl zinc, methylalumoxane, trimethylaluminum, triisobutylaluminum, trioctylaluminum, or a combination thereof.

### Polymerizations Using Trim

Polymerizations processes of the present disclosure can be performed using a “trim” process.

For delivery of a catalyst slurry to a reactor, a high solids concentration of the slurry typically increases the slurry viscosity. A high solids concentration also increases the amount of foaming which is typically generated in a catalyst slurry vessel. A high slurry viscosity and foaming can cause handling problems, storage problems as well as reactor injection problems. Low viscosity diluents can be added to the slurry to reduce the viscosity. However, the reduced viscosity promotes settling of the slurry in the solution, which can result in plugging of reactor components and accumulation of solids on the walls of catalyst slurry vessels.

A second catalyst solution can be added (i.e. “trimmed”) to the slurry to adjust one or more properties “in-situ” of polymer being formed in a reactor. Such “trim” processes are very economical because they do not require a polymerization to cease in order to adjust polymer properties in the event a catalyst system is not behaving in a desirable way. However, a second catalyst is typically delivered to the slurry as a low viscosity solution, which can promote settling of the slurry solution and subsequent gelling and/or plugging of reactor components.

Accordingly, processes for polymerizing olefin(s) can include using dual catalyst systems. In particular, methods include combining a catalyst component slurry with a catalyst component solution (to “trim”) to form a third catalyst composition and introducing the third composition into a polymerization reactor.

In some embodiments, a method includes: contacting a first composition and a second composition in a line leading to the reactor to form a third composition. The first composition includes a first catalyst, a second catalyst, a support, and a diluent. The second composition includes a second catalyst and a second diluent. The method includes introducing the third composition from the line into a gas-phase fluidized bed reactor and exposing the third composition to polymerization conditions. The method includes obtaining a polyolefin.

Processes can include adjusting reactor conditions, such as an amount of second catalyst fed to the reactor, to control one or more polymer properties of the polyolefin obtained from the reactor.

Metal bis(imino) aryl catalyst compounds of the present disclosure can be the first catalyst or second catalyst used in a trim process. The first or second catalyst can be a different metal bis(imino) aryl catalyst or can be a catalyst that is not a metal bis(imino) aryl catalyst such as a metallocene, such as the metallocene EtInd (i.e., 1-EtIndenyl₂ZrMe₂) or HfP (i.e., (nPrCyclopentadienyl)₂HfMe₂. Other exemplary metallocene catalyst compounds are described in US Pub. No. 2022/0033536, incorporated by reference herein.

By using structures such as a metal bis(imino) aryl catalyst as the second catalyst trimmed on-line at various ratios onto slurry feeding the first catalyst, or vice versa, along with varying reactor conditions involving temperature, reaction mixture component concentrations, and the like, beneficial polyolefin products may be formed.

Additionally, it should also be contemplated that for the distinct catalysts selected, some of the second catalyst may be initially co-deposited with the first catalyst on a common support, and the remaining amount of the first catalyst or second catalyst added as trim.

The catalyst system may include a catalyst compound in a slurry and an added solution catalyst component that is added to the slurry. Generally, the first catalyst and/or second catalyst will be supported in the initial slurry, depending on solubility. However, in at least one embodiment, the initial catalyst component slurry may have no catalysts. In this case, two or more solution catalysts may be added as “trim” to the slurry to cause each to be supported.

The slurry may include one or more activators and supports, and one or more catalyst compounds. For example, the slurry may include two or more activators (such as alumoxane and a modified alumoxane) and a catalyst compound, or the slurry may include a supported activator and more than one catalyst compounds. In at least one embodiment, the slurry includes a support, an activator, and two catalyst compounds. In another embodiment the slurry includes a support, an activator and two different catalyst compounds, which may be added to the slurry separately or in combination. The slurry, containing silica and alumoxane, may be contacted with a catalyst compound, allowed to react, and thereafter the slurry is contacted with another catalyst compound, for example, as “trim.”

One or more diluents can be used to facilitate the combination of any two or more components of the catalyst system in the slurry or in the trim catalyst solution. For example, the single site catalyst compound and the activator can be combined together in the presence of toluene or another non-reactive hydrocarbon or hydrocarbon mixture to provide the catalyst mixture. In addition to toluene, other suitable diluents can include, but are not limited to, ethylbenzene, xylene, pentane, hexane, heptane, octane, other hydrocarbons, or any combination thereof. The support, either dry or mixed with toluene can then be added to the catalyst mixture or the catalyst/activator mixture can be added to the support.

The diluent can be or include mineral oil. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The diluent can further include a wax, which can provide increased viscosity to a slurry (such as a mineral oil slurry). A wax is a food grade petrolatum also known as petroleum jelly. A wax can be a paraffin wax. Paraffin waxes include SONO JELL© paraffin waxes, such as SONO JELL© 4 and SONO JELL© 9 from Sonneborn, LLC. In at least one embodiment, a slurry has 5 wt % or greater of wax, such as 10 wt % or greater, such as 25 wt % or greater, such as 40 wt % or greater, such as 50 wt % or greater, such as 60 wt % or greater, such as 70 wt % or greater. For example, a mineral oil slurry can have about 70 wt % mineral oil, about 10 wt % wax, and about 20 wt % supported catalyst(s) (e.g., supported dual catalysts). The increased viscosity provided by a wax in a slurry, such as a mineral oil slurry, provides reduced settling of supported catalyst(s) in a vessel or catalyst pot. Also, using an increased viscosity mineral oil slurry does not inhibit trim efficiency. In at least one embodiment, a wax has a density of about 0.7 g/cm³ (at 100° C.) to about 0.95 g/cm³ (at 100° C.), such as about 0.75 g/cm³ (at 100° C.) to about 0.87 g/cm³ (at 100° C.). A wax can have a kinematic viscosity of about 5 mm²/s (at 100° C.) to about 30 mm²/s (at 100° C.). A wax can have a boiling point of about 200° C. or greater, such as about 225° C. or greater, such as about 250° C. or greater. A wax can have a melting point of about 25° C. to about 100° C., such as about 35° C. to about 80° C.

The catalyst component solution (referred to as the “trim” solution) may include only catalyst compound(s) or may include an activator. In at least one embodiment, the catalyst compound(s) in the catalyst component solution is unsupported. The catalyst solution used in a trim process can be prepared by dissolving the catalyst compound and optional activators in a liquid solvent. The liquid solvent may be an alkane, such as a C₅ to C₃₀ alkane, or a C₅ to C₁₀ alkane. Cyclic alkanes such as cyclohexane and aromatic compounds such as toluene may also be used. Mineral oil may be used as a solvent alternatively or in addition to other alkanes such as a C₅ to C₃₀ alkane. Mineral oil can have a density of about 0.85 g/cm³ to about 0.9 g/cm³ at 25° C. according to ASTM D4052, such as about 0.86 g/cm³ to about 0.88 g/cm³. Mineral oil can have a kinematic viscosity at 25° C. of about 150 cSt to about 200 cSt according to ASTM D341, such as about 160 cSt to about 190 cSt, such as about 170 cSt. Mineral oil can have an average molecular weight of about 400 g/mol to about 600 g/mol according to ASTM D2502, such as about 450 g/mol to about 550 g/mol, such as about 500 g/mol. In at least one embodiment, a mineral oil is HYDROBRITE® 380 PO White Mineral Oil (“HB380”) from Sonneborn, LLC.

The solution employed should be liquid under the conditions of polymerization and relatively inert. In at least one embodiment, the liquid utilized in the catalyst compound solution is different from the diluent used in the catalyst component slurry. In another embodiment, the liquid utilized in the catalyst compound solution is the same as the diluent used in the catalyst component solution.

In alternative embodiments, the catalyst is not limited to a slurry arrangement, as a mixed catalyst system may be made on a support and dried. The dried catalyst system can then be fed to the reactor through a dry feed system.

In gas-phase polyethylene production processes, it may be desirable to use one or more static control agents to aid in regulating static levels in the reactor. As used herein, a static control agent is a chemical composition which, when introduced into a fluidized bed reactor, may influence or drive the static charge (negatively, positively, or to zero) in the fluidized bed. The specific static control agent used may depend upon the nature of the static charge, and the choice of static control agent may vary dependent upon the polymer being produced and the single site catalyst compounds being used.

Control agents such as aluminum stearate may be employed. The static control agent used may be selected for its ability to receive the static charge in the fluidized bed without adversely affecting productivity. Other suitable static control agents may also include aluminum distearate, ethoxylated amines, and anti-static compositions.

### Polyolefin Products

The present disclosure relates to compositions of matter produced by the methods described herein.

In at least one embodiment, a process described herein produces C₂ to C₂₀ olefin homopolymers (e.g., polyethylene; polypropylene), or C₂ to C₂₀ olefin copolymers (e.g., ethylene-octene, ethylene-propylene) and or propylene-alpha-olefin copolymers, such as C₃ to C₂₀ copolymers (such as propylene-hexene copolymers or propylene-octene copolymers).

In at least one embodiment, a polymer of the present disclosure has an Mw of about 10,000 g/mol to about 500,000 g/mol, such as about 100,000 g/mol to about 350,000 g/mol, such as about 150,000 g/mol to about 300,000 g/mol, such as about 150,000 g/mol to about 225,000 g/mol, such as about 170,000 g/mol to about 225,000 g/mol.

In at least one embodiment, a polymer of the present disclosure has an Mn of about 1,000 g/mol to about 100,000 g/mol, such as about 2,500 g/mol to about 50,000 g/mol, such as about 5,000 g/mol to about 25,000 g/mol, such as about 7,500 g/mol to about 15,000 g/mol, such as about 9,000 g/mol to about 13,000 g/mol.

In at least one embodiment, a polymer of the present disclosure has an Mw/Mn (PDI) value of about 5 to about 25, such as about 10 to about 22, such as about 12 to about 20, such as about 15 to about 17, alternatively about 18 to about 20.

In at least one embodiment, a polymer of the present disclosure can have a melt index ratio (MIR, I₂₁/I₂) of about 10 to less than 300, or, in many embodiments, about 30 to about 100, such as about 50 to about 80, such as about 55 to 65, alternatively about 65 to about 80. The MIR can be determined according to D1238 (190° C., 21.6 kg load).

In at least one embodiment, a polymer of the present disclosure can have a melt index (MI, I₂) of about 0.2 g/10 minutes to about 10 g/10 minutes, such as about 0.3 g/10 minutes to about 3 g/10 minutes, such as about 0.3 g/10 minutes to about 1 g/10 minutes. The MI can be measured in accordance with ASTM D1238 (190° C., 2.16 kg load).

In at least one embodiment, a polymer of the present disclosure can have a high load melt index (HLMI, I₂₁) of about 0.2 g/10 minutes to 100 g/10 minutes, such as about 20 g/10 minutes to about 70 g/10 minutes, such as about 20 g/10 minutes to about 45 g/10 minutes, alternatively about 45 g/10 minutes to about 70 g/10 minutes, alternatively about 40 g/10 minutes to about 50 g/10 minutes, alternatively about 50 g/10 minutes to about 60 g/10 minutes, as determined by ASTM D1238 (190° C., 21.6 kg load).

In some embodiments, the ethylene based copolymer may have a g′ᵥᵢₛ that is about 0.7 or more (such as about 0.75 or more, such as about 0.8 or more, 0.85 or more, such as 0.9 or more, such as 0.95 or more, for example about 0.96, about 0.965, about 0.97, about 0.975, about 0.98, about 0.985, about 0.99, about 0.995, or about 1).

In at least one embodiment, a polymer of the present disclosure can have a density of about 0.89 g/cm³, about 0.90 g/cm³, or about 0.91 g/cm³ to about 0.95 g/cm³, about 0.96 g/cm³, or about 0.97 g/cm³. For example, the density can be about 0.94 g/cm³ to about 0.970 g/cm³, such as about 0.946 g/cm³ to about 0.96 g/cm³, such as about 0.95 g/cm³ to about 0.96 g/cm³, alternatively about 0.955 g/cm³ to about 0.957 g/cm³. Density can be determined in accordance with ASTM D792. Density is expressed as grams per cubic centimeter (g/cm³) unless otherwise noted.

In at least one embodiment, a polymer of the present disclosure can have a bulk density of about 0.25 g/cm³ to about 0.5 g/cm³, such as about 0.25 g/cm³ to about 0.4 g/cm³, such as about 0.3 g/cm³ to about 0.35 g/cm³. For example, the bulk density of the polyethylene can be about 0.30 g/cm³, about 0.32 g/cm³, or about 0.33 g/cm³ to about 0.40 g/cm³, about 0.36 g/cm³, or about 0.35 g/cm³, alternatively about 0.4 g/cm³ to about 0.5 g/cm³. The bulk density can be measured in accordance with ASTM D1895 method B.

Likewise, a process of the present disclosure produces olefin polymers, such as polyethylene and polypropylene homopolymers and copolymers. In at least one embodiment, the polymers produced herein are homopolymers of ethylene or copolymers of ethylene having, for example, about 0.00001 wt % to about 8 wt % (alternately about 0.00001 wt % to about 2 wt %, such as about 0.05 wt % to about 1.5 wt %, such as about 0.75 wt % to about 1 wt %, of one or more C₃ to C₂₀ olefin comonomer (such as C₃ to Cu alpha-olefin, such as propylene, butene, hexene, octene, decene, dodecene, such as propylene, butene, hexene, octene). In at least one embodiment, the monomer is ethylene and the comonomer is hexene, such as about 0.00001 wt % to about 5 wt % hexene, such as about 0.00001 wt % to about 2 wt % hexene, such as about 0.8 wt % to about 1.3 wt % hexene, alternatively about 1.3 wt % to about 1.7 wt %, based on the weight of the polymer.

In at least one embodiment, a polymer produced herein has a unimodal or multimodal molecular weight distribution as determined by Gel Permeation Chromatography (GPC). By “unimodal” is meant that the GPC trace has one peak or inflection point. By “multimodal” is meant that the GPC trace has at least two peaks or inflection points. An inflection point is that point where the second derivative of the curve changes in sign (e.g., from negative to positive or vice versus).

### GPC 4-D

Unless otherwise indicated, the distribution and the moments of molecular weight (Mw, Mn, Mz, Mw/Mn, etc.), the comonomer content and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering about 2700 cm⁻¹ to about 3000 cm⁻¹(representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ˜300 ppm antioxidant BHT can be used as the mobile phase at a nominal flow rate of ˜1.0 mL/minute and a nominal injection volume of ˜200 μL. The whole system including transfer lines, columns, and detectors can be contained in an oven maintained at ˜145° C. A given amount of sample can be weighed and sealed in a standard vial with ˜10 μL flow marker (heptane) added thereto. After loading the vial in the auto-sampler, the oligomer or polymer may automatically be dissolved in the instrument with ˜8 mL added TCB solvent at ˜160° C. with continuous shaking. The sample solution concentration can be from ˜0.2 to ˜2.0 mg/ml, with lower concentrations used for higher molecular weight samples. The concentration, c, at each point in the chromatogram can be calculated from the baseline-subtracted IR5 broadband signal, I, using the equation: c=αI, where a is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10 M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, a and K for other materials are as calculated by GPC ONE™ software (Polymer Characterization, S. A., Valencia, Spain). Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH₃ channel calibrated with a series of PE and PP homo/copolymer standards whose nominal value are predetermined by NMR or FTIR. In particular, this provides the methyls per 1000 total carbons (CH₃/1000TC) as a function of molecular weight. The short-chain branch (SCB) content per 1000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH₂ channels between the integration limits of the concentration chromatogram. First, the following ratio is obtained

$$Bulk IR ratio = \frac{Area of {CH}_{3} signal within integration limits}{Area of {CH}_{2} signal within integration limits} .$$

Then the same calibration of the CH₃ and CH₂ signal ratio, as mentioned previously in obtaining the CH3/1000TC as a function of molecular weight, is applied to obtain the bulk CH3/1000TC. A bulk methyl chain ends per 1000TC (bulk CH3end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and Ko is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system, n=1.500 for TCB at 145° C. and λ=665 nm. For analyzing polyethylene homopolymers, ethylene-hexene copolymers, and ethylene-octene copolymers, dn/dc=0.1048 ml/mg and A2=0.0015; for analyzing ethylene-butene copolymers, dn/dc=0.1048*(1-0.00126*w2) ml/mg and A2=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, ηs, for the solution flowing through the viscometer is calculated from their outputs. The intrinsic viscosity, [η], at each point in the chromatogram is calculated from the equation [η]=ηs/c, where c is concentration and is determined from the IR5 broadband channel output. The viscosity MW at each point is calculated as M=K_{PS}M^{α}^{_{PS}}/[7], where aps is 0.67 and Kₚₛ is 0.000175.

The branching index (g′ᵥᵢₛ) is calculated using the output of the GPC-IR5-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits. The branching index g′ᵥᵢₛ is defined as

$${g}_{vis}^{′} = \frac{{[ η ]}_{avg}}{{KM}_{v}^{α}} ,$$

where Mᵥ is the viscosity-average molecular weight based on molecular weights determined by LS analysis and the, K and α are for the reference linear polymer, which are, for purposes of this present disclosure, α=0.700 and K=0.0003931 for ethylene, propylene, diene monomer copolymers, α=0.705 and K=0.0002288 for linear propylene polymers, α=0.695 and K=0.000181 for linear butene polymers, a is 0.695 and K is 0.000579*(1-0.0087*w2b+0.000018*(w2b)\hat{ }2) for ethylene-butene copolymer where w2b is a bulk weight percent of butene comonomer, α is 0.695 and K is 0.000579*(1-0.0075*w2b) for ethylene-hexene copolymer where w2b is a bulk weight percent of hexene comonomer, and a is 0.695 and K is 0.000579*(1-0.0077*w2b) for ethylene-octene copolymer where w2b is a bulk weight percent of octene comonomer, and α=0.695 and K=0.000579 for linear ethylene polymers, for all other linear ethylene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

### Blends

In another embodiment, the polymer (such as the polyethylene or polypropylene) produced herein is combined with one or more additional polymers prior to being formed into a film, molded part or other article. Other useful polymers include polyethylene, isotactic polypropylene, highly isotactic polypropylene, syndiotactic polypropylene, random copolymer of propylene and ethylene, and or butene, and or hexene, polybutene, ethylene vinyl acetate, LDPE, LLDPE, HDPE, ethylene vinyl acetate, ethylene methyl acrylate, copolymers of acrylic acid, polymethylmethacrylate or any other polymers polymerizable by a high-pressure free radical process, polyvinylchloride, polybutene-1, isotactic polybutene, ABS resins, ethylene-propylene rubber (EPR), vulcanized EPR, EPDM, block copolymer, styrenic block copolymers, polyamides, polycarbonates, PET resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, and or polyisobutylene.

In at least one embodiment, the polymer (such as the polyethylene or polypropylene) is present in the above blends, at about 10 wt % to about 99 wt %, based upon the weight of the polymers in the blend, such as about 20 wt % to about 95 wt %, such as at least about 30 wt % to about 90 wt %, such as at least about 40 wt % to about 90 wt %, such as at least about 50 wt % to about 90 wt %, such as at least about 60 wt % to about 90 wt %, such as at least about 70 to about 90 wt %.

Additionally, additives may be included in the blend, in one or more components of the blend, and or in a product formed from the blend, such as a film, as desired. Such additives are well known in the art, and can include, for example: fillers; antioxidants (e.g., hindered phenolics such as IRGANOX™ 1010 or IRGANOX™” 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

### Films

Any of the foregoing polymers, or blends thereof, may be used in a variety of end-use applications. Such applications include, for example, mono- or multi-layer blown, extruded, and or shrink films. These films may be formed by any number of well-known extrusion or coextrusion techniques, such as a blown bubble film processing technique, wherein the composition can be extruded in a molten state through an annular die and then expanded to form a uni-axial or biaxial orientation melt prior to being cooled to form a tubular, blown film, which can then be axially slit and unfolded to form a flat film. Films may be subsequently unoriented, uniaxially oriented, or biaxially oriented to the same or different extents. One or more of the layers of the film may be oriented in the transverse and or longitudinal directions to the same or different extents. The uniaxially orientation can be accomplished using suitable cold drawing or hot drawing methods. Biaxial orientation can be accomplished using tenter frame equipment or a double bubble processes and may occur before or after the individual layers are brought together. For example, a polyethylene layer can be extrusion coated or laminated onto an oriented polypropylene layer or the polyethylene and polypropylene can be coextruded together into a film then oriented. Likewise, oriented polypropylene could be laminated to oriented polyethylene or oriented polyethylene could be coated onto polypropylene then optionally the combination could be oriented even further. However, in another embodiment the film is oriented to the same extent in both the MD and TD directions.

The films may vary in thickness depending on the intended application; however, films of a thickness of about 1 μm to about 50 μm can be suitable. Films intended for packaging can be about 10 μm to about 50 μm thick. The thickness of the sealing layer can be about 0.2 μm to about 50 μm. There may be a sealing layer on both the inner and outer surfaces of the film or the sealing layer may be present on only the inner or the outer surface.

### EXAMPLES

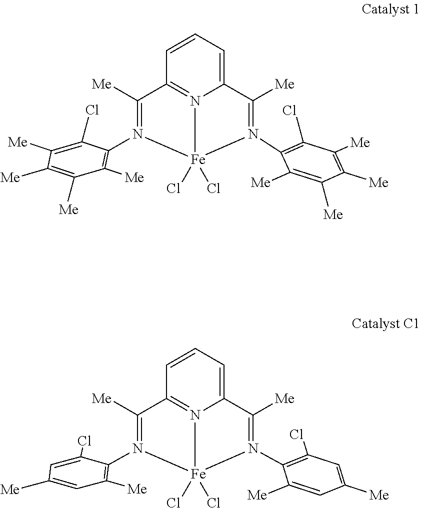

### Experimental Procedures.

### General Considerations and Reagents.

All manipulations were performed under an inert atmosphere using glove box techniques unless otherwise stated. Toluene and Pentane (Sigma Aldrich) were degassed and dried over 3 Å molecular sieves overnight prior to use. Methylaluminoxane was purchased from Grace and used as received. 2,6-bisacetylpyridine (TCI chemicals) used as purchased. 2-chloro-4,6-dimethylaniline, Ethanol, acetic acid, FeCl₂ and FeCl₃ were purchased from Sigma Aldrich and used as received.

### Scheme 1: Synthesis of (E)-N-(2-chloro-3,4,5,6-tetramethyl-phenyl)-1-[6-[(E)-N-(2-chloro-3,4,5,6-tetramethyl-phenyl)-C-methyl-carbonimidoyl]-2-pyridyl]ethanimine

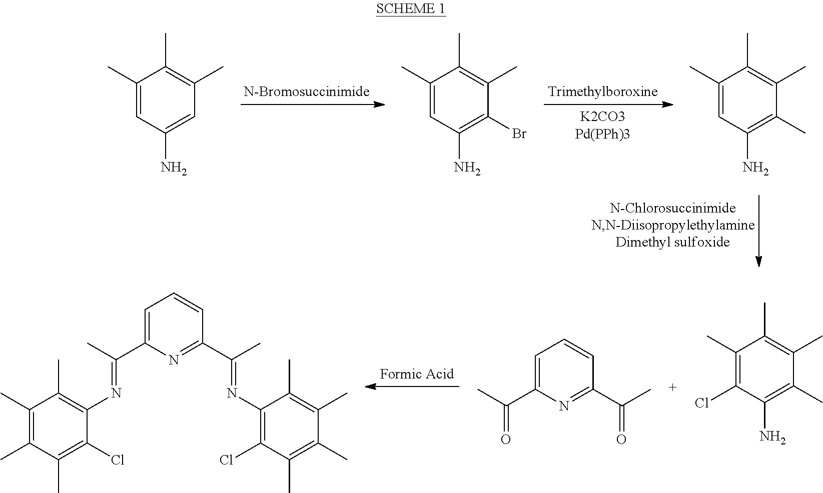

A 1L round bottom was charged with 3,4,5-trimethylaniline (Combi-Blocks, 10 g, 74.0 mmol, 1 eq). The flask was evacuated and back-filled with N₂ (×3). Anhydrous dichloromethane (750 mL) was added, and the solution was cooled in a dry ice/acetonitrile bath (≈45° C.). N-Bromosuccinimide (13.2 g, 70.3 mmol, 0.95 eq) was added all at once. The reaction was stirred overnight with gradual warming. The red-orange solution was concentrated via rotary evaporation. The residue was partitioned between diethyl ether and 1N NaOH. The layers were separated. The organic layer was washed with additional NaOH (×1), water (×1), brine (×1) and dried over MgSO₄. The MgSO₄ was filtered off, and the filtrate was concentrated via rotary evaporation. The resulting residue was dried under vacuum. The resulting residue (≈16 g) was dissolved in hexane and the solution was purified via filter column of basic alumina (activity grade IV, 5× by mass, ≈80 g), eluting with hexane. The product fractions were combined and concentrated via rotary evaporation. ¹H NMR of the resulting solid was consistent with the desired product. A small amount of impurity (≈2%) was also present. 13.85 g (92% yield) of slightly impure 2-bromo-3,4,5-trimethyl-aniline was collected as a pale orange solid. ¹H NMR (400 MHz, C6D6, δH=7.16): δ 6.07 (s, 1H), 3.41 (broad s, 2H), 2.26 (s, 3H), 1.96 (s, 3H), 1.86 (s, 3H).

In the drybox a 200 mL pressure vessel was charged with trimethylboroxine (2.2 g, 17.5 mmol, 1.5 eq). 1,4-Dioxane (100 mL) was added followed by 2-bromo-3,4,5-trimethyl-aniline (2.5 g, 11.7 mmol, 1 eq) and K₂CO₃ (4.06 g, 29.2 mmol, 2.5 eq). The resulting suspension was treated with Pd(PPh₃)₄(0.675 g, 0.58 mmol, 5 mol %). The vessel was sealed with the bushing and heated to 115° C. over the weekend. After cooling to room temperature the reaction was transferred to the hood and poured onto ice/water. After the ice had melted the pH was adjusted to ≈2-3. The resulting mixture was filtered through Celite, rinsing with water. The filtrate was adjusted to pH≈7-8 with 1N NaOH. The mixture was extracted with diethyl ether (×2). The combined ether layers were washed with water (×2), brine (×1), and dried over MgSO₄. The MgSO₄ was filtered off, and the filtrate was concentrated via rotary evaporation. The residue was redissolved in Et₂O and purified via plug filtration through a short pad of silica gel. The filtrate was concentrated via rotary evaporation. ¹H NMR of the resulting solid was consistent with the desired product. A small amount of impurity (≈2%) was also present. 1.3232 g (76% yield) of slightly impure 2,3,4,5-tetramethylaniline was collected as an orange solid. 1H NMR (400 MHz, C6D6, δH=7.16): δ 6.22 (s, 1H), 2.81 (broad s, 2H), 2.15 (s, 3H), 2.06 (s, 3H), 2.05 (s, 3H), 1.86 (s, 3H).

In the air a 50 mL round bottom was charged with N-Chlorosuccinimide (recrystallized from acetic acid, 0.268 g, 2.0 mmol, 1.2 eq). CHCl₃ (12 mL) was added, and the resulting stirred solution was placed in a room temperature water bath. A solution of 2,3,4,5-tetramethylaniline (0.250 g, 1.68 mmol, 1 eq), dimethyl sulfoxide (0.131 g, 1.68 mmol, 1 eq), and N,N-diisopropylethylamine (0.217 g, 1.68 mmol, 1 eq) in CHCl₃ (4 mL) was added dropwise. The reaction was stirred overnight. The reaction was concentrated via rotary evaporation at room temperature. The resulting residue was partitioned between diethyl ether/0.1 N HCl. The layers were separated. The ether layer was washed with 0.1 N HCl (×2), 1N NaOH (×1), brine (×1), and dried over MgSO₄. The MgSO₄ was filtered off, and the filtrate was concentrated via rotary evaporation. The residue was dissolved in 10% dichloromethane in hexane and loaded on to a basic alumina column (activity grade IV, which refers to water (10% wt/total wt) added to activity grade I alumina) prepared in the same solvent. The column was eluted with the same solvent. The mostly clean product fractions (visualized using 12) were combined and concentrated via rotary evaporation. ¹H NMR of the resulting solid was consistent with the desired product. 0.135 g (44% yield) of the product was isolated as a red-orange solid. ¹H NMR (400 MHz, C6D6, δH=7.16): δ 3.51 (broad s, 2H), 2.29 (s, 3H), 1.94 (overlapping s, 6H), 1.75 (s, 3H).

A 20 mL vial was charged with 2,6-diacetylpyridine (0.05 g. 0.31 mmol, 1 eq). Methanol (2 mL) was added. The vial was sealed with a septum, and the solution was sparged with N₂ to degas (3 minutes). Formic acid (1 drop) was added followed by 2-chloro-3,4,5,6-tetramethylaniline (0.124 g, 0.67 mmol, 2.2 eq) was added. After 5 hours at room temperature under N₂, the vial was transferred to the box, closed with a lid, and heated to 67° C. After reacting at temperature overnight solids had formed in the vial. The reaction was cooled to room temperature, transferred to the hood, diluted with additional methanol (≈2 mL), and transferred to the freezer. After 1 hour the solids were collected via vacuum filtration, rinsing with cold methanol. The filter cake was dried under vacuum. ¹H NMR of the yellow solids was consistent with the product. 0.152 g (64% yield) of (E)-N-(2-chloro-3,4,5,6-tetramethyl-phenyl)-1-[6-[(E)-N-(2-chloro-3,4,5,6-tetramethyl-phenyl)-C-methyl-carbonimidoyl]-2-pyridyl]ethanimine was isolated as a yellow solid. ¹H NMR (400 MHz, C6D6, δH=7.16): δ 8.62-8.59 (m, 2H), 7.26 (t, J=7.8 Hz, 1H), 2.35-2.34 (m, 12H), 2.03-1.95 (m, 18H).

### Synthesis of (1E,1′E)-1,1′-(pyridine-2,6-diyl)bis(N-(2-chloro-3,4,5,6 tetramethylphenyl) ethan-1-imine)Iron(H)Chloride

To the solution of (1E,1′E)-1,1′-(pyridine-2,6-diyl)bis(N-(2-chloro-3,4,5,6-tetramethylphenyl)ethan-1-imine) (670 mg, 1.35 mmol, 1.00 equiv.) in THE at −35° C. was added FeCl₂ (172 mg, 1.35 mmol, 1.00 equiv.) to give a dark blue mixture. The reaction mixture was stirred overnight at room temperature, then evaporated under vacuum, leaving dark blue solid. The solid was washed with diethyl ether (10 ml) and pentane (10 ml) and dried. The solid was then extracted with dichloromethane (30 mL, then 3×5 mL) and the extracts were filtered to give a dark blue solution. The solvent was evaporated under vacuum, leaving blue solid. The yield was 782 mg (93%). ¹H NMR (CD₂Cl₂) 22.64 (s), 11.82 (s), 0.95 (s), −4.13 (dt), −8.87 (s), −23.21 (dt), −25.47 (S).

### Supportation Activation of Catalyst 1

### Procedure of Supportation of Catalyst 1:

MAO (41.6 g in 30 wt % in toluene) was added to the celestir along with 200 ml of toluene. The solution was allowed to stir for two minutes. The catalyst (Catalyst 1) (876 mg) was added to the MAO solution. The reaction mixture was allowed to stir for an hour at room temperature. Then ES70 875 silica (34.5 g) was added to the above mixture and stir for another hour. The solid support was filtered and washed with 200 ml of pentane. Then the supported catalyst was dried under vacuum for 8 hours yield dry support.

### Polymerization Process:

Polymerizations were performed in a 7 foot tall gas-phase fluidized bed reactor with a 4 foot tall 6″ diameter body and a 3 foot tall 10″ diameter expanded section. Cycle and feed gases were fed into the reactor body through a perforated distributor plate, and the reactor was controlled at 300 psi and 70 mol % ethylene. Reactor temperature was maintained by heating the cycle gas. Supported catalyst was fed as a 10 wt % slurry in SONO JELL® from Sonneborn (Parsippany, NJ). The slurry was delivered to the reactor by nitrogen and isopentane feeds in a ⅛″ diameter catalyst probe. Polymer was collected from the reactor as necessary to maintain the desired bed weight. Average process conditions for the polymer collection are shown in Table 1.

TABLE 1
Average process conditions for collection

| | Run Condition # | | | |
|---|---|---|---|---|
| | 1 | 2 | 3 | 4 |
| | Catalyst # | | | |
| | C1 | Cat. 1 | Cat. 1 | Cat. 1 |
| PROCESS DATA | | | | |
| H₂ conc. (mol ppm) | 6 | 400 | 800 | 3205 |
| Hydrogen flow (sccm) | 0.00 | 8.38 | 17.03 | 70.27 |
| C₆/C₂ Ratio (mol %/mol %) | 0.023 | 0.029 | 0.042 | 0.041 |
| Comonomer conc. (mol %) | 1.61 | 2.07 | 2.94 | 2.87 |
| C₂ conc. (mol %) | 70.0 | 70.1 | 70.0 | 70.3 |
| Comonomer/C₂ Flow Ratio | 0.053 | 0.053 | 0.080 | 0.080 |
| C₂ flow (g/hr) | 2065 | 1714 | 1641 | 1646 |
| H₂/C2 Ratio | 0.1 | 5.7 | 11.4 | 45.6 |
| Rx. Pressure (psig) | 300 | 300 | 299 | 299 |
| Reactor Temp (F.) | 185 | 185 | 185 | 185 |
| Avg. Bedweight (g) | 2362 | 2349 | 2355 | 2335 |
| Production (g/hr) | 214 | 522 | 469 | 482 |
| Residence Time (hr) | 11.0 | 4.5 | 5.0 | 4.8 |
| C₂ Utilization (gC₂/gC₂ poly) | 9.64 | 3.28 | 3.50 | 3.42 |
| Avg Velocity (ft/s) | 1.41 | 1.41 | 1.45 | 1.49 |
| Catalyst Slurry Feed (ml/hr) | 4.0 | 1.6 | 1.6 | 1.6 |
| Catalyst Slurry Conc. (wt frac.) | 0.1 | 0.1 | 0.1 | 0.1 |
| Catalyst Slurry Density (g/ml) | 0.88 | 0.88 | 0.88 | 0.88 |
| Trim Feed (ml/hr) | 0.00 | | | |
| Catalyst Feed (g/hr) | 0.350 | 0.141 | 0.141 | 0.140 |
| Cat Activity (g poly/g cat) | 612 | 3694 | 3319 | 3444 |
| Product Data | | | | |
| Melt Index (MI) | 61.04 | 0.32 | 0.76 | 0.93 |
| HLMI | 0.00 | 24.38 | 44.19 | 57.59 |
| HLMI/MI Ratio | 0.00 | 76.55 | 58.30 | 62.00 |
| Gradient Density | N/A | 0.9555 | 0.9559 | 0.9567 |
| Bulk Density | 0.3813 | 0.3363 | 0.3170 | 0.3445 |
| Mn | 4,677 | 12,666 | 11,335 | 9,006 |
| Mw | 57,414 | 213,444 | 174,311 | 169,944 |
| Mw/Mn | 12.28 | 16.85 | 15.38 | 18.87 |
| Hexene wt % | 0.42 | 1.62 | 1.42 | 0.92 |
| g'ᵥᵢₛ | 0.914 | 1 | 1 | 1 |

Overall, catalyst compounds of the present disclosure can provide enhanced solubility and capability of forming polymers at high catalyst activities. The polymers can having a high molecular weight, high density in the presence of alpha-olefins, and fractional melt index.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby. Likewise, the term “comprising” is considered synonymous with the term “including” for purposes of United States law. Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A compound represented by Formula (I): 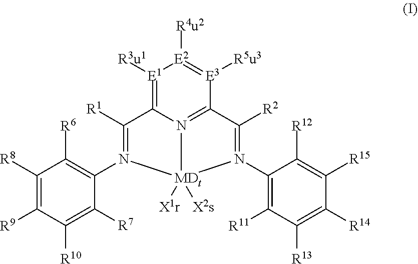
wherein:
M is Fe or Co;
each of R¹ and R² is independently hydrogen, C₁-C₄₀ hydrocarbyl, or five-, or six-, or seven-membered heterocyclic ring comprising at least one atom selected from the group consisting of N, P, O and S; wherein each of R¹ and R² is optionally substituted with halogen, —OR¹⁶, or —NR¹⁷₂;
each of R³, R⁴, and R⁵ is independently hydrogen, C₁-C₄₀ hydrocarbyl, —OR¹⁶, —NR¹⁷₂ halogen, or five-, six-, or seven-membered heterocyclic ring comprising at least one atom selected from the group consisting of N, P, O and S; wherein each of R³, R⁴, and R⁵ is optionally substituted with halogen, —OR¹⁶, or —NR¹⁷₂;
each of R⁸, R⁹, R¹⁰, R¹³, R¹⁴, and R¹⁵ is independently C₁-C₄₀ hydrocarbyl, —OR¹⁶, —NR¹⁷₂ halogen, or five-, six-, or seven-membered heterocyclic ring comprising at least one atom selected from the group consisting of N, P, O and S; wherein each of R³, R⁴, R⁵, R⁸, R⁹, R¹⁰, R¹³, R¹⁴, and R¹⁵ is optionally substituted with halogen, —OR¹⁶, or —NR¹⁷₂;
each of R⁶, R⁷, R¹¹, and R¹² is independently C₁-C₄₀ hydrocarbyl, a heteroatom or a heteroatom-containing group; wherein each of R⁶, R⁷, R¹¹, and R¹² is optionally substituted with halogen, —OR¹⁶, or —NR¹⁷₂;
wherein R¹ optionally is bonded to R³, R² optionally is bonded to R⁵, R³ optionally is bonded to R⁴, R⁴ optionally is bonded to R⁵, R⁷ optionally is bonded to R¹⁰, R¹⁰ optionally is bonded to R⁹, R⁹ optionally is bonded to R⁸, R⁸ optionally is bonded to R⁶, R¹⁵ optionally is bonded to R¹⁴, R¹⁴ optionally is bonded to R¹³, R¹³ optionally is bonded to R¹¹, R¹⁵ optionally is bonded to R¹², in each case to independently form a five-, six-, or seven-membered carbocyclic or heterocyclic ring, the heterocyclic ring comprising at least one atom from the group consisting of N, P, O and S;
each of R¹⁶ and R¹⁷ is independently hydrogen, oxygen, C₁-C₂₂ alkyl, C₂-C₂₂ alkenyl, or C₆-C₂₂ aryl, wherein each R¹⁶ and R¹⁷ is independently optionally substituted with halogen, or two R¹⁶ radicals optionally bond to form a five- or six-membered ring, or two R¹⁷ radicals optionally bond to form a five- or six-membered carbocyclic or heterocyclic ring, the heterocyclic ring comprising at least one atom from the group consisting of N, P, O and S;
each of E¹, E², and E³ is independently carbon, nitrogen or phosphorus;
u¹ is 0 if E¹ is nitrogen or phosphorus, u² is 0 if E² is nitrogen or phosphorus, u³ is 0 if E³ is nitrogen or phosphorus, u¹ is 1 if E¹ is carbon, u² is 1 if E² is carbon, and u³ is 1 if E³ is carbon;
each of X¹ and X² is independently an anionic ligand, wherein X¹ optionally is bonded to X² to form a five-, six-, or seven-membered carbocyclic or heterocyclic ring, the heterocyclic ring comprising at least one atom from the group consisting of N, P, O and S;
r is 1 or 2;
s is 1 or 2;
D is a neutral donor;
t is 0 to 2; and
the sum of r, s, and t is 3 or less.

2. The compound of claim 1, wherein M is Fe.

3. The compound of claim 2, wherein each of X¹ and X² is a halide.

4. The compound of claim 3, wherein:
each of E¹, E², and E³ is carbon,
each of u¹, u², and u³ is 1,
r is 1,
s is 1, and
t is 0.

5. The compound of claim 4, wherein each of R¹ and R² is independently C₁-C₂₂ alkyl or C₆-C₂₂ aryl.

6. The compound of claim 5, wherein R⁶ is halogen, —CF₃, —OR¹⁶, or —NR¹⁷₂ and R⁷ is C₁-C₁₀ alkyl, wherein each of R¹⁶ and R¹⁷ of R⁶, if present, is independently hydrogen or C₁-C₂₂ alkyl.

7. The compound of claim 6, wherein each of R⁸, R⁹, and R¹⁰ is independently C₁-C₁₀ alkyl, C₂-C₁₀ alkenyl, C₆-C₁₀ aryl, or halogen.

8. The compound of claim 7, wherein R¹¹ is halogen, —CF₃, —OR¹⁶, or —NR¹⁷₂ and R¹² is C₁-C₁₀ alkyl, wherein each of R¹⁶ and R¹⁷ of R¹¹, if present, is independently hydrogen or C₁-C₂₂ alkyl.

9. The compound of claim 1, wherein each of R⁶, R⁷, R¹¹, and R¹² is independently selected from the group consisting of methyl, ethyl, tert-butyl, F, Br, Cl, and I.

10. The compound of claim 8, wherein each of R¹³, R¹⁴, and R¹⁵ is independently C₁-C₂₂ alkyl, C₂-C₂₂ alkenyl, C₆-C₂₂ aryl, halogen, —NO₂, or five-, six-, or seven-membered heterocyclic ring including at least one atom selected from the group consisting of N, P, O, and S.

11. The compound of claim 10, wherein each of R¹³, R¹⁴, and R¹⁵ is independently C₁-C₁₀ alkyl.

12. The compound of claim 1, wherein each of R⁶, R⁷, R⁸, R⁹, R¹⁰, R¹¹, R¹², R¹³, R¹⁴, and R¹⁵ is independently selected from the group consisting of fluorine, chlorine, methyl, ethyl, propyl, butyl, pentyl, hexyl, heptyl, octyl, nonyl, decyl, undecyl, dodecyl, phenyl, and biphenyl.

13. The compound of claim 1, wherein one or more of R¹, R², R³, R⁴, R⁵, R⁶, R⁷, R⁸, R⁹, R¹⁰, R¹¹, R¹², R¹³, R¹⁴, and R¹⁵ is a hydrocarbyl that is substituted, wherein the substituted hydrocarbyl is represented by the formula —(R¹⁸)A(R¹⁹)(R²⁰)(R²¹), wherein:
A is Si or Ge;
R¹⁸ is C₁-C₁₀ hydrocarbyl;
each of R¹⁹, R²⁰, and R²¹ is independently C₁-C₄₀ hydrocarbyl, and
R¹⁹ optionally is bonded to R²⁰, R²⁰ optionally is bonded to R²¹, and R¹⁹ optionally is bonded to R²¹, in each case to independently form a five-, six-, or seven-membered carbocyclic or heterocyclic ring, the heterocyclic ring formed by two of R¹⁹, R²⁰, or R²¹ comprising at least one atom from the group consisting of N, P, O and S.

14. The compound of claim 1, wherein the compound is selected from the group consisting of:

| | |
|---|---|
| 1 | 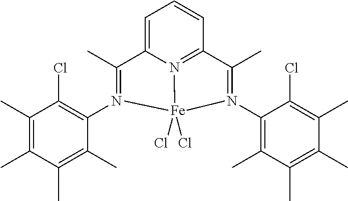 |
| 2 | 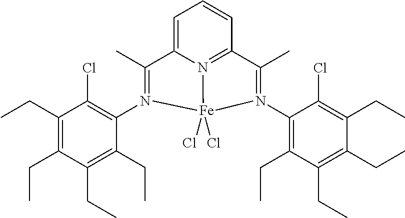 |
| 3 | 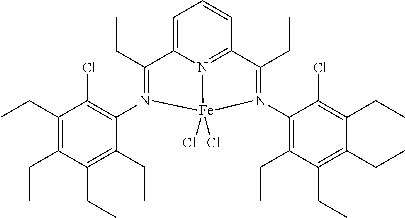 |
| 4 | 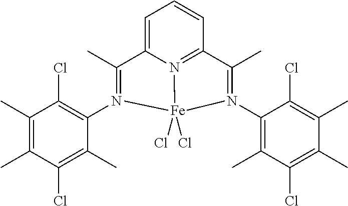 |
| 5 | 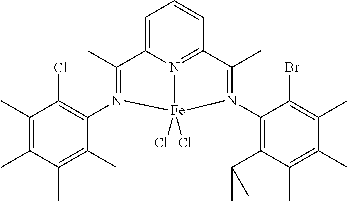 |
| 6 | 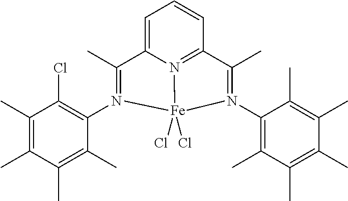 |
| 7 | 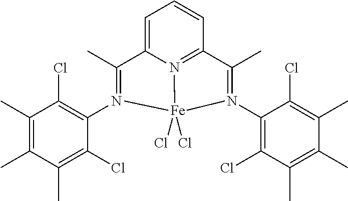 |
| 8 | 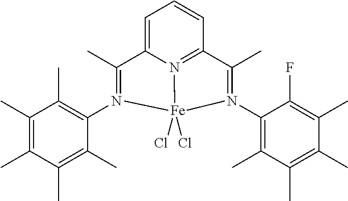 |
| 9 | 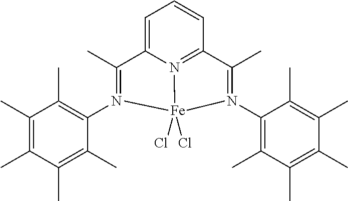 |

15. The compound of claim 14, wherein the compound is:

| | |
|---|---|
| 1 | 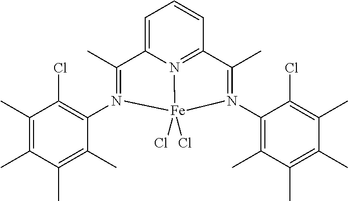 |

16. A catalyst system comprising an activator and the compound of claim 1.

17. The catalyst system of claim 16, further comprising a support material.

18. The catalyst system of claim 17, wherein the support material is selected from the group consisting of Al₂O₃, ZrO₂, SiO₂, SiO₂/Al₂O₃, SiO₂/TiO₂, silica clay, silicon oxide/clay, and mixtures thereof.

19. The catalyst system of claim 16, wherein the activator comprises a non-coordinating anion activator.

20. The catalyst system of claim 16, wherein the activator comprises an alkylalumoxane.

21. A process for producing an ethylene alpha-olefin copolymer, the process comprising: polymerizing ethylene and at least one C₃-C₂₀ alpha-olefin by introducing the ethylene and the at least one C₃-C₂₀ alpha-olefin with the catalyst system of claim 16, in a reactor, at a reactor pressure of about 0.05 MPa to about 1,500 MPa and a reactor temperature of about 30° C. to about 230° C. to form the ethylene alpha-olefin copolymer.

22. The process of claim 21, wherein the catalyst system has a catalyst productivity of about 700 gP/gCat/hr to about 850 gP/gCat/hr.

23. The process of claim 21, wherein the ethylene alpha-olefin copolymer has:
a weight average molecular weight (Mw) of about 150,000 g/mol to about 225,000 g/mol,
a number average molecular weight (Mn) of about 7,500 g/mol to about 15,000 g/mol,
a polydispersity index (Mw/Mn) of about 12 to about 20,
a melt index ratio (MIR) of about 50 to about 80,
a melt index (MI) of about 0.3 g/10 minutes to about 1 g/10 minutes,
a high load melt index (HLMI) of about 20 g/10 minutes to about 45 g/10 minutes,
a g′ᵥᵢₛ of about 0.98 or greater, and
a density of about 0.95 g/cm³ to about 0.96 g/cm³.

24. The process of claim 21, wherein the catalyst system further comprises a second compound represented by Formula (I) or a metallocene catalyst compound.

25. The process of claim 24, wherein the reactor is a gas-phase fluidized bed reactor and the process further comprises:
forming the catalyst system by contacting a first composition and a second composition in a line coupled with at least one of the reactors to form a third composition, wherein:
the first composition comprises the compound, the activator, the second compound, a wax, and a diluent, the second composition comprises the second compound and a second diluent; and
introducing the third composition from the line into the gas-phase fluidized bed reactor.
